(19) United States
(12) Patent Application Publication
(10) Pub. No.: US 2026/0052357 A1
(43) Pub. Date: Feb. 19, 2026

(54) METHOD FOR TRANSMITTING MESSAGE IN WIRELESS COMMUNICATION SYSTEM AND APPARATUS THEREFOR

(71) Applicant: LG ELECTRONICS INC., Seoul (KR)

(72) Inventors: Jaeho HWANG, Seoul (KR); Hakseong KIM, Seoul (KR); Hanbyul SEO, Seoul (KR); Min SONG, Seoul (KR)

(21) Appl. No.: 19/111,265

(22) PCT Filed: Sep. 18, 2023
(86) PCT No.: PCT/KR2023/014025

§ 371 Date: Mar. 12, 2025

(30) Foreign Application Priority Data
Sep. 16, 2022 (KR) 10-2022-0117404
Sep. 16, 2022 (KR) 10-2022-0117419

(51) Int. Cl. H04W 4/021; H04W 4/12; H04W 4/44

(52) U.S. Cl. CPC H04W 4/021; H04W 4/12; H04W 4/44

(57) ABSTRACT

A method by which a first device comprising reception queues and transmission queues transmits a message in a wireless communication system, according to various embodiments, may comprise the steps of: receiving a first message including a first zone identifier (ID) from a second device; receiving a plurality of messages from a plurality of apparatuses; identifying a zone ID corresponding to each of the plurality of messages; and transmitting, to the second device, at least one message included in at least one transmission queue selected on the basis of a transmission priority from among the transmission queues into which selected messages have been input.

### CROSS-REFERENCE TO RELATED APPLICATIONS

This application is a National Phase application under 35 U.S.C. 371 of International Application No. PCT/KR2023/014025, filed on Sep. 18, 2023, which claims the benefit of Korean Application No. 10-2022-0117404, filed on Sep. 16, 2022 and No. 10-2022-0117419, filed on Sep. 16, 2022, the contents of which are incorporated by reference herein in their entirety.

### TECHNICAL FIELD

The present disclosure relates to a method of transmitting a message by a first device in a wireless communication system and device therefor.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

A sidelink (SL) refers to a communication method in which a direct link is established between user equipment (UE), and voice or data is directly exchanged between terminals without going through a base station (BS). SL is being considered as one way to solve the burden of the base station due to the rapidly increasing data traffic.

V2X (vehicle-to-everything) refers to a communication technology that exchanges information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR). Even in NR, vehicle-to-everything (V2X) communication may be supported.

FIG. 1 is a diagram comparing RAT-based V2X communication before NR with NR-based V2X communication.

Regarding V2X communication, in RAT prior to NR, a scheme for providing a safety service based on V2X messages such as a basic safety message (BSM), a cooperative awareness message (CAM), and a decentralized environmental notification message (DENM) was mainly discussed. The V2X message may include location information, dynamic information, and attribute information. For example, the UE may transmit a periodic message type CAM and/or an event triggered message type DENM to another UE.

For example, the CAM may include dynamic state information about a vehicle such as direction and speed, vehicle static data such as dimensions, and basic vehicle information such as external lighting conditions and route details. For example, a UE may broadcast the CAM, and the CAM latency may be less than 100 ms. For example, when an unexpected situation such as a breakdown of the vehicle or an accident occurs, the UE may generate a DENM and transmit the same to another UE. For example, all vehicles within the transmission coverage of the UE may receive the CAM and/or DENM. In this case, the DENM may have a higher priority than the CAM.

Regarding V2X communication, various V2X scenarios have been subsequently introduced in NR. For example, the various V2X scenarios may include vehicle platooning, advanced driving, extended sensors, and remote driving.

For example, based on vehicle platooning, vehicles may dynamically form a group and move together. For example, to perform platoon operations based on vehicle platooning, vehicles belonging to the group may receive periodic data from a leading vehicle. For example, the vehicles belonging to the group may reduce or increase the distance between the vehicles based on the periodic data.

For example, based on advanced driving, a vehicle may be semi-automated or fully automated. For example, each vehicle may adjust trajectories or maneuvers based on data acquired from local sensors of nearby vehicles and/or nearby logical entities. Also, for example, each vehicle may share driving intention with nearby vehicles.

For example, on the basis of extended sensors, raw data or processed data acquired through local sensors, or live video data may be exchanged between a vehicle, a logical entity, UEs of pedestrians and/or a V2X application server. Thus, for example, the vehicle may recognize an environment that is improved over an environment that may be detected using its own sensor.

For example, for a person who cannot drive or a remote vehicle located in a dangerous environment, a remote driver or V2X application may operate or control the remote vehicle based on remote driving. For example, when a route is predictable as in the case of public transportation, cloud computing-based driving may be used to operate or control the remote vehicle. For example, access to a cloud-based back-end service platform may be considered for remote driving.

A method to specify service requirements for various V2X scenarios such as vehicle platooning, advanced driving, extended sensors, and remote driving is being discussed in the NR-based V2X communication field.

### SUMMARY

The present disclosure aims to provide a method of operating multiple queues based on a reception priority and a transmission priority, selecting or filtering at least one message from a plurality of received messages based on the reception priority and the transmission priority, and prioritizing and transmitting the selected or filtered messages and device therefor.

It will be appreciated by persons skilled in the art that the objects that could be achieved with the various embodiments of the present disclosure are not limited to what has been particularly described hereinabove and the above and other objects that the various embodiments of the present disclosure could achieve will be more clearly understood from the following detailed description.

In an aspect of the present disclosure, provided herein is a method of transmitting a message by a first device having reception queues and transmission queues in a wireless communication system. The method include: receiving a first message including a first zone identifier (ID) from a second device; receiving a plurality of messages from a plurality of devices; identifying a zone ID corresponding to each of the plurality of messages; and transmitting at least one message to the second device. The plurality of messages may be input into the reception queues based on a reception priority determined based on a message type. Filtered messages included in at least one reception queue, which is selected based on the reception priority from the reception queues into which the plurality of messages are input, may be input into the transmission queues based on a transmission priority corresponding to the identified zone ID. The at least one message may be a message included in at least one transmission queue selected based on the transmission priority from the transmission queues into which the filtered messages are input.

Alternatively, each of the plurality of messages may be input into a reception queue with the determined reception priority among the reception queues, and each of the filtered messages may be input into a transmission queue with the transmission priority corresponding to the identified zone ID among the transmission queues.

Alternatively, the at least one reception queue may be a reception queue with a relatively higher reception priority among the reception queues, and the at least one transmission queue may be a transmission queue with a relatively higher transmission priority among the transmission queues.

Alternatively, the first message may include a vehicle-to-network (V2N) header including information on the first zone ID and a message reception type, and the transmission priority may be preconfigured for each of a plurality of zone IDs based on the message reception type and the first zone ID included in the V2N header.

Alternatively, a network may specify the locations of dummy bits on a payload based on the locations and bit length of starting bits and update a single message based on the specified locations of the dummy bits without decoding the payload.

Alternatively, the message reception type may indicate one of a reception type prioritizing all directions, a reception type prioritizing a direction of travel, a reception type prioritizing risk areas, or reception type prioritizing designated zones.

Alternatively, based on that the message reception type is the reception type prioritizing all directions, the transmission priority may be preconfigured for each of the plurality of zone IDs based on a distance to an area corresponding to the first zone ID.

Alternatively, based on that the message reception type is the reception type prioritizing the direction of travel, the transmission priority may be preconfigured for each of the plurality of zone IDs based on a distance to an area corresponding to the first zone ID and the direction of travel of the second device.

Alternatively, based on that the message reception type is the reception type prioritizing the risk areas, the transmission priority may be preconfigured for each of the plurality of zone IDs based on accident occurrences in an area corresponding to the first zone ID and changes in locations of other devices.

Alternatively, the first device may be a V2N server, and each of the first message and the plurality of messages may be a V2N message transmitted to the V2N server.

Alternatively, each of the plurality of messages may include a V2N header including information related to the reception priority for the message type, and the first device may determine the reception priority for each of the plurality of messages based on the V2N header.

In another aspect of the present disclosure, provided herein is a first device having reception queues and transmission queues and configured to transmit messages in a wireless communication system. The first device may include: a radio frequency (RF) transceiver; and a processor connected to the RF transceiver. The processor may be configured to: control the RF transceiver to receive a first message including a first zone ID from a second device; receive a plurality of messages from a plurality of devices; identify a zone ID corresponding to each of the plurality of messages; and transmit at least one message to the second device. The plurality of messages may be input into the reception queues based on a reception priority determined based on a message type. Filtered messages included in at least one reception queue, which is selected based on the reception priority from the reception queues into which the plurality of messages are input, may be input into the transmission queues based on a transmission priority corresponding to the identified zone ID. The at least one message may be a message included in at least one transmission queue selected based on the transmission priority from the transmission queues into which the filtered messages are input.

In a further aspect of the present disclosure, provided herein is a method of receiving, by a second device, messages from a first device having reception queues and transmission queues in a wireless communication system. The method may include: transmitting a first message including information on a first zone ID and a message reception type to the first device; and receiving at least one message among a plurality of messages for a plurality of devices from the first device. The plurality of messages may be input into the reception queues based on a reception priority determined based on a message type. Filtered messages included in at least one reception queue, which is selected based on the reception priority from the reception queues into which the plurality of messages are input, may be input into the transmission queues based on a transmission priority corresponding to the identified zone ID. The at least one message may be a message included in at least one transmission queue selected based on the transmission priority from the transmission queues into which the filtered messages are input.

According to various embodiments, even when broadband communication is performed based on a cellular network, it is possible to select and filter at least one message from a plurality of received messages according to a reception priority and a transmission priority by operating a plurality of queues based on the reception priority and the transmission priority

Alternatively, a device receiving vehicle-to-network (V2N) services may not need to receive all V2N messages for surrounding devices. That is, the device may selectively receive V2N messages for devices located in areas of interest to the device.

Alternatively, a device providing V2N services may easily and effectively select at least one message of interest to a device receiving the V2N services among a plurality of V2N messages by using a plurality of queues based on a reception priority and a transmission priority.

Effects to be achieved by embodiment(s) are not limited to what has been particularly described hereinabove and other effects not mentioned herein will be more clearly understood by persons skilled in the art to which embodiment(s) pertain from the following detailed description.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a diagram for explaining by comparing V2X communication based on RAT before NR and V2X communication based on NR.

FIG. 2 illustrates the structure of an LTE system to which embodiment(s) are applicable.

FIG. 3 illustrates the structure of an NR system to which embodiment(s) are applicable.

FIG. 4 illustrates the structure of an NR radio frame to which embodiment(s) are applicable.

FIG. 5 illustrates the slot structure of an NR frame to which embodiment(s) are applicable.

FIG. 6 illustrates a radio protocol architecture for SL communication.

FIG. 7 illustrates UEs performing V2X or SL communication.

FIG. 8 illustrates resource units for V2X or SL communication.

FIG. 9 is a diagram for explaining an ITS station reference architecture.

FIG. 10 illustrates an exemplary structure of an ITS station that may be designed and applied based on a reference architecture.

FIG. 11 is a diagram for explaining the configuration of a vehicle-to-network (V2N) communication system.

FIGS. 12 to 14 are diagrams for explaining methods for a V2N server to connect user equipments (UEs) based on zones.

FIGS. 15 and 16 are block diagrams schematically illustrating the configurations of a V2N server and V2N client that transmit and receive receiving messages based on a zone identifier (ID).

FIGS. 17 and 18 are diagrams for explaining methods of converting location information into a zone ID and managing a zone list.

FIG. 19 is a diagram for explaining the structure of a V2N message.

FIG. 20 is a diagram for explaining the configuration of a V2N server including V2N message reception queues and transmission queues.

FIGS. 21 to 23 are diagrams for explaining methods for a V2N server to forward received V2N messages to a UE based on the reception area configuration of the UE.

FIG. 24 is a diagram for explaining the structure of a V2N message including information on a priority and a reception type.

FIG. 25 is a diagram for explaining a method by which a first device transmits a V2N message to a second device.

FIG. 26 is a diagram for explaining a method by which a second device receives a message from a first device.

FIG. 27 illustrates a communication system applied to the present disclosure.

FIG. 28 illustrates wireless devices applicable to the present disclosure.

FIG. 29 illustrates another example of a wireless device to which the present disclosure is applied.

FIG. 30 illustrates a vehicle or an autonomous driving vehicle applied to the present disclosure.

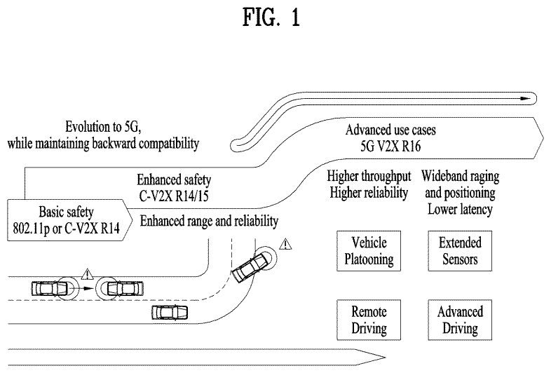

### DETAILED DESCRIPTION

The wireless communication system is a multiple access system that supports communication with multiple users by sharing available system resources (e.g., bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency (SC-FDMA) system, a multi carrier frequency division multiple access (MC-FDMA) system, and the like.

A sidelink refers to a communication scheme in which a direct link is established between user equipments (UEs) to directly exchange voice or data between UEs without assistance from a base station (BS). The sidelink is being considered as one way to address the burden on the BS caused by rapidly increasing data traffic.

Vehicle-to-everything (V2X) refers to a communication technology for exchanging information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive MTC, and Ultra-Reliable and Low Latency Communication (URLLC) may be referred to as new radio access technology (RAT) or new radio (NR). Even in NR, V2X communication may be supported.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

5G NR is a successor technology of LTE-A and is a new clean-slate mobile communication system with characteristics such as high performance, low latency, and high availability. 5G NR may utilize all available spectrum resources, from low frequency bands below 1 GHz to intermediate frequency bands from 1 GHz to 10 GHz and high frequency (millimeter wave) bands above 24 GHz.

For clarity of explanation, LTE-A or 5G NR is mainly described, but the technical spirit of the embodiment(s) is not limited thereto

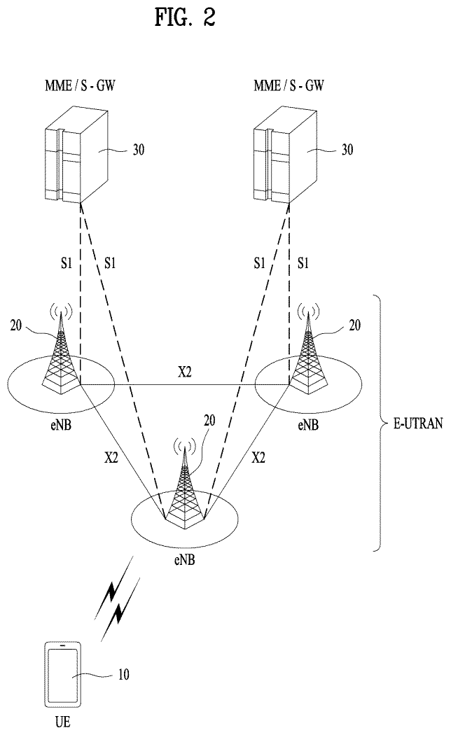

FIG. 2 illustrates the structure of an LTE system to which the present disclosure is applicable. This may also be called an evolved UMTS terrestrial radio access network (E-UTRAN) or LTE/LTE-A system.

Referring to FIG. 2, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

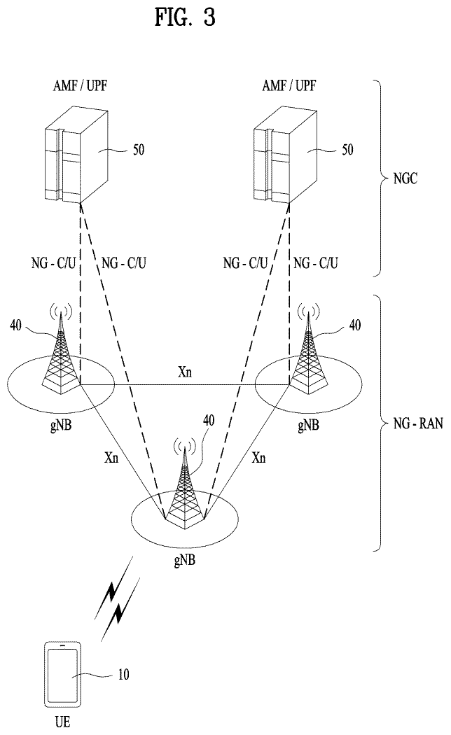

FIG. 3 illustrates the structure of a NR system to which the present disclosure is applicable.

Referring to FIG. 3, a next generation radio access network (NG-RAN) may include a next generation Node B (gNB) and/or an eNB, which provides user-plane and control-plane protocol termination to a UE. In FIG. 3, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

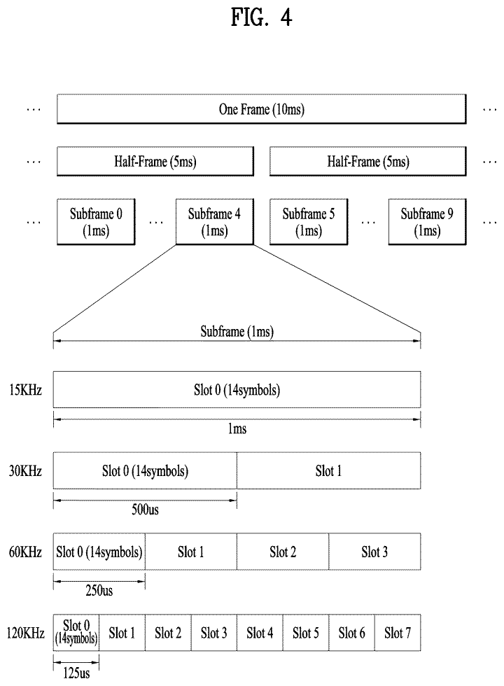

FIG. 4 illustrates the structure of a NR radio frame to which the present disclosure is applicable.

Referring to FIG. 4, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM (A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot N^{slot}_{symb}, the number of slots per frame N^{frame,u}ₛₗₒₜ, and the number of slots per subframe N^{subframe,u}ₛₗₒₜ according to an SCS configuration μ in the NCP case.

TABLE 1

| SCS (15*2u) | N^{slot}_{symb} | N^{frame, u}ₛₗₒₜ | N^{subframe, u}ₛₗₒₜ |
|---|---|---|---|
| 15 kHz (u = 0) | 14 | 10 | 1 |
| 30 kHz (u = 1) | 14 | 20 | 2 |
| 60 kHz (u = 2) | 14 | 40 | 4 |
| 120 kHz (u = 3) | 14 | 80 | 8 |
| 240 kHz (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | Nslotsymb | Nframe, uslot | Nsubframe, uslot |
|---|---|---|---|
| 60 kHz (u = 2) | 12 | 40 | 4 |

In the NR system, different OFDM (A) numerologies (e.g., SCSs, CP lengths, etc.) may be configured for a plurality of cells aggregated for one UE. Thus, the (absolute) duration of a time resource (e.g., SF, slot, or TTI) including the same number of symbols may differ between the aggregated cells (such a time resource is commonly referred to as a time unit (TU) for convenience of description).

In NR, multiple numerologies or SCSs to support various 5G services may be supported. For example, a wide area in conventional cellular bands may be supported when the SCS is 15 kHz, and a dense urban environment, lower latency, and a wider carrier bandwidth may be supported when the SCS is 30 kHz/60 kHz. When the SCS is 60 kHz or higher, a bandwidth wider than 24.25 GHz may be supported to overcome phase noise.

The NR frequency band may be defined as two types of frequency ranges. The two types of frequency ranges may be FR1 and FR2. The numerical values of the frequency ranges may be changed. For example, the two types of frequency ranges may be configured as shown in Table 3 below. Among the frequency ranges used in the NR system, FR1 may represent “sub 6 GHz range” and FR2 may represent “above 6 GHz range” and may be called millimeter wave (mmW).

TABLE 3

| Frequency Range | Corresponding | Subcarrier |
|---|---|---|
| designation | frequency range | Spacing (SCS) |
| FR1 | 450 MHz-6000 MHz | 15, 30, 60 kHz |
| FR2 | 24250 MHz-52600 MHz | 60, 120, 240 kHz |

As mentioned above, the numerical values of the frequency ranges of the NR system may be changed. For example, FR1 may include a band of 410 MHz to 7125 MHz as shown in Table 4 below. That is, FR1 may include a frequency band of 6 GHZ (or 5850 MHz, 5900 MHz, 5925 MHz, etc.) or higher. For example, the frequency band of 6 GHz (or 5850 MHz, 5900 MHz, 5925 MHz, etc.) or higher included in FR1 may include an unlicensed band. The unlicensed band may be used for various purposes, for example, for communication for vehicles (e.g., autonomous driving).

TABLE 4

| Frequency Range | Corresponding | Subcarrier |
|---|---|---|
| designation | frequency range | Spacing (SCS) |
| FR1 | 410 MHz-7125 MHz | 15, 30, 60 kHz |
| FR2 | 24250 MHz-52600 MHz | 60, 120, 240 kHz |

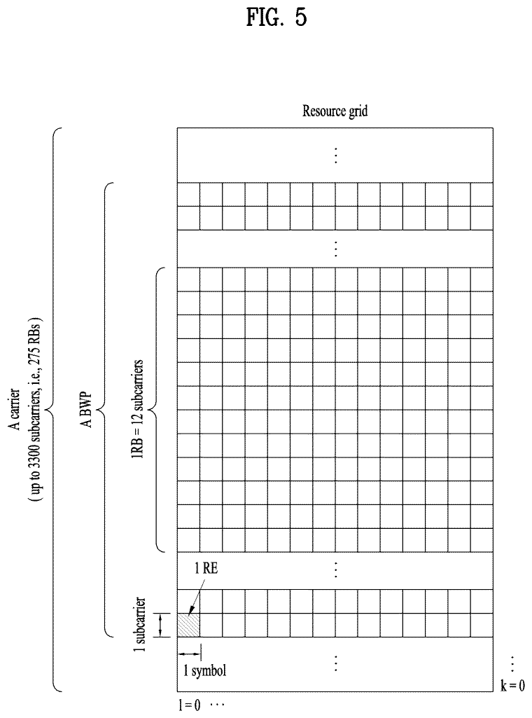

FIG. 5 illustrates the slot structure of a NR frame to which the present disclosure is applicable.

Referring to FIG. 5, one slot includes a plurality of symbols in the time domain. For example, one slot may include 14 symbols in a normal CP and 12 symbols in an extended CP. Alternatively, one slot may include 7 symbols in the normal CP and 6 symbols in the extended CP.

A carrier may include a plurality of subcarriers in the frequency domain. A resource block (RB) is defined as a plurality of consecutive subcarriers (e.g., 12 subcarriers) in the frequency domain. A bandwidth part (BWP) may be defined as a plurality of consecutive (P) RBs in the frequency domain, and the BWP may correspond to one numerology (e.g., SCS, CP length, etc.). The carrier may include up to N (e.g., 5) BWPs. Data communication may be conducted in an activated BWP. In a resource grid, each element may be referred to as a resource element (RE) and may be mapped to one complex symbol.

The wireless interface between UEs or the wireless interface between a UE and a network may be composed of an L1 layer, an L2 layer, and an L3 layer. In various embodiments of the present disclosure, the L1 layer may represent a physical layer. The L2 layer may represent, for example, at least one of a MAC layer, an RLC layer, a PDCP layer, and an SDAP layer. The L3 layer may represent, for example, an RRC layer.

Hereinafter, V2X or sidelink (SL) communication will be described.

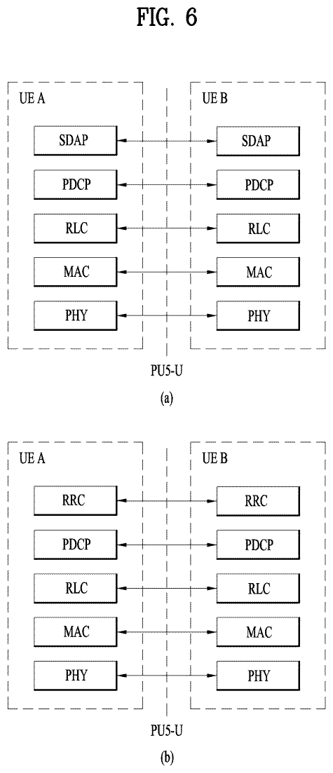

FIG. 6 illustrates a radio protocol architecture for SL communication. Specifically, FIG. 6-(a) shows a user plane protocol stack of NR, and FIG. 6-(b) shows a control plane protocol stack of NR.

Hereinafter, a sidelink synchronization signal (SLSS) and synchronization information will be described.

The SLSS is an SL-specific sequence, and may include a primary sidelink synchronization signal (PSSS) and a secondary sidelink synchronization signal (SSSS). The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, the UE may detect an initial signal and acquire synchronization using the S-PSS. For example, the UE may acquire detailed synchronization using the S-PSS and the S-SSS, and may detect a synchronization signal ID.

A physical sidelink broadcast channel (PSBCH) may be a (broadcast) channel on which basic (system) information that the UE needs to know first before transmission and reception of an SL signal is transmitted. For example, the basic information may include SLSS related information, a duplex mode (DM), time division duplex uplink/downlink (TDD UL/DL) configuration, resource pool related information, the type of an application related to the SLSS, a subframe offset, and broadcast information. For example, for evaluation of PSBCH performance, the payload size of PSBCH in NR V2X may be 56 bits including CRC of 24 bits.

The S-PSS, S-SSS, and PSBCH may be included in a block format (e.g., an SL synchronization signal (SS)/PSBCH block, hereinafter sidelink-synchronization signal block (S-SSB)) supporting periodic transmission. The S-SSB may have the same numerology (i.e., SCS and CP length) as a physical sidelink control channel (PSCCH)/physical sidelink shared channel (PSSCH) in the carrier, and the transmission bandwidth thereof may be within a (pre)set sidelink BWP (SL BWP). For example, the bandwidth of the S-SSB may be 11 resource blocks (RBs). For example, the PSBCH may span 11 RBs. The frequency position of the S-SSB may be (pre)set. Accordingly, the UE does not need to perform hypothesis detection at a frequency to discover the S-SSB in the carrier.

In the NR SL system, a plurality of numerologies having different SCSs and/or CP lengths may be supported. In this case, as the SCS increases, the length of the time resource in which the transmitting UE transmits the S-SSB may be shortened. Thereby, the coverage of the S-SSB may be narrowed. Accordingly, in order to guarantee the coverage of the S-SSB, the transmitting UE may transmit one or more S-SSBs to the receiving UE within one S-SSB transmission period according to the SCS. For example, the number of S-SSBs that the transmitting UE transmits to the receiving UE within one S-SSB transmission period may be pre-configured or configured for the transmitting UE. For example, the S-SSB transmission period may be 160 ms. For example, for all SCSs, the S-SSB transmission period of 160 ms may be supported.

For example, when the SCS is 15 kHz in FR1, the transmitting UE may transmit one or two S-SSBs to the receiving UE within one S-SSB transmission period. For example, when the SCS is 30 kHz in FR1, the transmitting UE may transmit one or two S-SSBs to the receiving UE within one S-SSB transmission period. For example, when the SCS is 60 kHz in FR1, the transmitting UE may transmit one, two, or four S-SSBs to the receiving UE within one S-SSB transmission period.

For example, when the SCS is 60 kHz in FR2, the transmitting UE may transmit 1, 2, 4, 8, 16 or 32 S-SSBs to the receiving UE within one S-SSB transmission period. For example, when SCS is 120 kHz in FR2, the transmitting UE may transmit 1, 2, 4, 8, 16, 32 or 64 S-SSBs to the receiving UE within one S-SSB transmission period.

When the SCS is 60 kHz, two types of CPs may be supported. In addition, the structure of the S-SSB transmitted from the transmitting UE to the receiving UE may depend on the CP type. For example, the CP type may be normal CP (NCP) or extended CP (ECP). Specifically, for example, when the CP type is NCP, the number of symbols to which the PSBCH is mapped in the S-SSB transmitted by the transmitting UE may be 9 or 8. On the other hand, for example, when the CP type is ECP, the number of symbols to which the PSBCH is mapped in the S-SSB transmitted by the transmitting UE may be 7 or 6. For example, the PSBCH may be mapped to the first symbol in the S-SSB transmitted by the transmitting UE. For example, upon receiving the S-SSB, the receiving UE may perform an automatic gain control (AGC) operation in the period of the first symbol for the S-SSB.

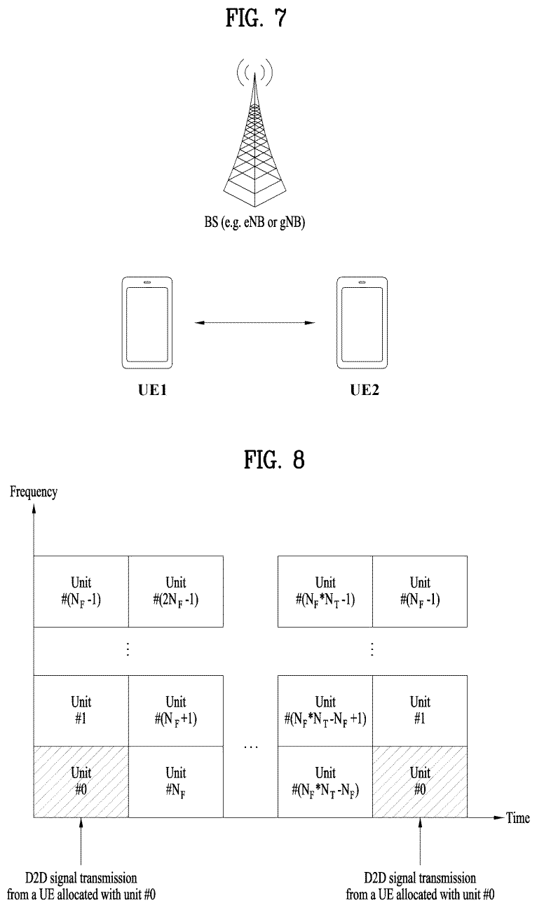

FIG. 7 illustrates UEs performing V2X or SL communication.

Referring to FIG. 7, in V2X or SL communication, the term UE may mainly refer to a user's UE. However, when network equipment such as a BS transmits and receives signals according to a communication scheme between UEs, the BS may also be regarded as a kind of UE. For example, UE 1 may be the first device 100, and UE 2 may be the second device 200.

For example, UE 1 may select a resource unit corresponding to a specific resource in a resource pool, which represents a set of resources. Then, UE 1 may transmit an SL signal through the resource unit. For example, UE 2, which is a receiving UE, may receive a configuration of a resource pool in which UE 1 may transmit a signal, and may detect a signal of UE 1 in the resource pool.

Here, when UE 1 is within the connection range of the BS, the BS may inform UE 1 of a resource pool. On the other hand, when the UE 1 is outside the connection range of the BS, another UE may inform UE 1 of the resource pool, or UE 1 may use a preconfigured resource pool.

In general, the resource pool may be composed of a plurality of resource units, and each UE may select one or multiple resource units and transmit an SL signal through the selected units.

FIG. 8 illustrates resource units for V2X or SL communication.

Referring to FIG. 8, the frequency resources of a resource pool may be divided into NF sets, and the time resources of the resource pool may be divided into NT sets. Accordingly, a total of NF*NT resource units may be defined in the resource pool. FIG. 8 shows an exemplary case where the resource pool is repeated with a periodicity of NT subframes.

As shown in FIG. 8, one resource unit (e.g., Unit #0) may appear periodically and repeatedly. Alternatively, in order to obtain a diversity effect in the time or frequency dimension, an index of a physical resource unit to which one logical resource unit is mapped may change in a predetermined pattern over time. In this structure of resource units, the resource pool may represent a set of resource units available to a UE which intends to transmit an SL signal.

Resource pools may be subdivided into several types. For example, according to the content in the SL signal transmitted in each resource pool, the resource pools may be divided as follows.
(1) Scheduling assignment (SA) may be a signal including information such as a position of a resource through which a transmitting UE transmits an SL data channel, a modulation and coding scheme (MCS) or multiple input multiple output (MIMO) transmission scheme required for demodulation of other data channels, and timing advance (TA). The SA may be multiplexed with SL data and transmitted through the same resource unit. In this case, an SA resource pool may represent a resource pool in which SA is multiplexed with SL data and transmitted. The SA may be referred to as an SL control channel.
(2) SL data channel (physical sidelink shared channel (PSSCH)) may be a resource pool through which the transmitting UE transmits user data. When the SA and SL data are multiplexed and transmitted together in the same resource unit, only the SL data channel except for the SA information may be transmitted in the resource pool for the SL data channel. In other words, resource elements (REs) used to transmit the SA information in individual resource units in the SA resource pool may still be used to transmit the SL data in the resource pool of the SL data channel. For example, the transmitting UE may map the PSSCH to consecutive PRBs and transmit the same.
(3) The discovery channel may be a resource pool used for the transmitting UE to transmit information such as the identifier (ID) thereof. Through this channel, the transmitting UE may allow a neighboring UE to discover the transmitting UE.

Even when the SL signals described above have the same content, they may use different resource pools according to the transmission/reception properties of the SL signals. For example, even when the SL data channel or discovery message is the same among the signals, it may be classified into different resource pools according to determination of the SL signal transmission timing (e.g., transmission at the reception time of the synchronization reference signal or transmission by applying a predetermined TA at the reception time), a resource allocation scheme (e.g., the BS designates individual signal transmission resources to individual transmitting UEs or individual transmission UEs select individual signal transmission resources within the resource pool), signal format (e.g., the number of symbols occupied by each SL signal in a subframe, or the number of subframes used for transmission of one SL signal), signal strength from a BS, the strength of transmit power of an SL UE, and the like.

### Vehicular Communications for ITS

An intelligent transport system (ITS) utilizing vehicle-to-everything (V2X) may mainly include an access layer, a network & transport layer, a facilities layer, an application layer, security and management entities, etc. Vehicle communication may be applied to various scenarios such as vehicle-to-vehicle communication (V2V), vehicle-to-network communication (V2N or N2V), vehicle-to-road side unit (RSU) communication (V2I or I2V), RSU-to-RSU communication (I2I), vehicle-to-pedestrian communication (V2P or P2V), and RSU-to-pedestrian communication (I2P or P2I). A vehicle, a BS, an RSU, a pedestrian, etc. as the subjects of vehicle communication are referred to as ITS stations.

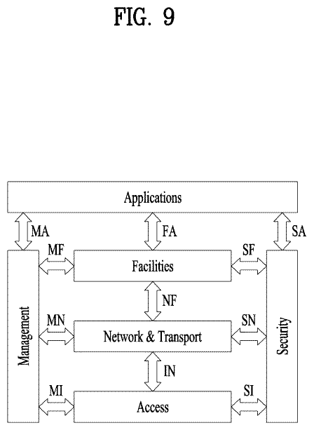

FIG. 9 is a diagram for explaining an ITS station reference architecture.

The ITS station reference architecture may include an access layer, a network & transport layer, a facilities layer, entities for security and management, and an application layer at the top. Basically, the ITS station reference architecture follows a layered OSI model.

Specifically, features of the ITS station reference architecture based on the OSI model are illustrated in FIG. 9. The access layer of the ITS station corresponds to OSI layer 1 (physical layer) and layer 2 (data link layer), the network & transport layer of the ITS station corresponds to OSI layer 3 (network layer) and layer 4 (transport layer), and the facilities layer of the ITS station corresponds to OSI layer 5 (session layer), layer 6 (presentation layer), and layer 7 (application layer).

The application layer, which is located at the highest layer of the ITS station, may actually implement and support a use-case and may be selectively used according to the use-case. The management entity serves to manage all layers in addition to managing communication and operations of the ITS station. The security entity provides security services for all layers. Each layer of the ITS station exchanges data transmitted or received through vehicle communication and additional information for various purposes through an interface. The abbreviations of various interfaces are described below.
MA: Interface between management entity and application layer
MF: Interface between management entity and facilities layer
MN: Interface between management entity and networking & transport layer
MI: Interface between management entity and access layer
FA: Interface between facilities layer and ITS-S applications
NF: Interface between networking & transport layer and facilities layer
IN: Interface between access layer and networking & transport layer
SA: Interface between security entity and ITS-S applications
SF: Interface between security entity and facilities layer
SN: Interface between security entity and networking & transport layer
SI: Interface between security entity and access layer

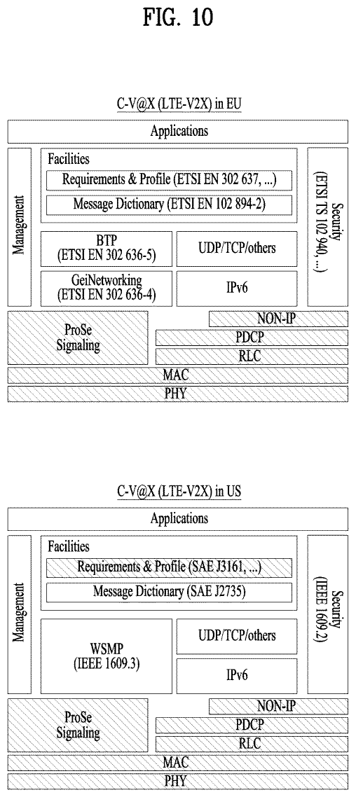

FIG. 10 illustrates an exemplary structure of an ITS station that may be designed and applied based on a reference architecture.

A main concept of the ITS station reference architecture is to allow each layer with a special function to process communication on a layer basis, between two end vehicles/users included in a communication network. That is, when a V2V message is generated, the data is passed through each layer downwards layer by layer in the vehicle and the ITS system (or other ITS-related UEs/systems), and a vehicle or ITS system (or other ITS-related UEs/systems) receiving the message passes the message upwards layer by layer.

The ITS system operating through vehicle communication and the network was organically designed in consideration of various access technologies, network protocols, communication interfaces, etc. to support various use-cases, and the roles and functions of each layer described below may be changed depending on a situation. The main functions of each layer will be briefly described.

The application later actually implements and supports various use-cases. For example, the application layer provides security, efficient traffic information, and other entertainment information.

The application layer controls an ITS station to which an application belongs in various manners or provides services by transferring a service message to an end vehicle/user/infrastructure through the access layer, the network & transport layer, and the facilities layer, which are lower layers of the application layer, by vehicle communication. In this case, the ITS application may support various use-cases. In general, these use-cases may be supported by grouping into other applications such as road-safety, traffic efficiency, local services, and infotainment. Application classification, use-cases, etc. may be updated when a new application scenario is defined. Layer management serves to manage and service information related to operation and security of the application layer, and the related information is transmitted and shared bidirectionally through an MA and an SA (or service access point (SAP), e.g., MA-SAP or SA-SAP). A request from the application layer to the facilities layer or a service message and related information from the facilities layer to the application layer may be delivered through an FA.

The facilities layer serves to support effective implementation of various use-cases defined in an application layer of a higher layer. For example, the facilities layer may perform application support, information support, and session/communication support.

The facilities layer basically supports the 3 higher layers of the OSI model, for example, a session layer, a presentation layer, and the application layer, and functions. Specifically, the facilities layer provides facilities such as application support, information support, and session/communication support, for the ITS. Here, the facilities mean components that provide functionality, information, and data.

The application support facilities support the operation of ITS applications (mainly generation of a message for the ITS, transmission and reception of the message to and from a lower layer, and management of the message). The application support facilities include a cooperative awareness (CA) basic service and a decentralized environmental notification (DEN) basic service. In the future, facilities entities for new services such as cooperative adaptive cruise control (CACC), platooning, a vulnerable roadside user (VRU), and a collective perception service (CPS), and related messages may be additionally defined.

The information support facilities provide common data information or a database to be used by various ITS applications and includes a local dynamic map (LDM).

The session/communication support facilities provide services for communications and session management and include an addressing mode and session support.

Facilities may be divided into common facilities and domain facilities.

The common facilities are facilities that provide common services or functions required for various ITS applications and ITS station operations, such as time management, position management, and service management.

The domain facilities are facilities that provide special services or functions required only for some (one or more) ITS applications, such as a DEN basic service for road hazard warning applications (RHW). The domain facilities are optional functions and are not used unless supported by the ITS station.

Layer management serves to manage and service information related to the operation and security of the facilities layer, and the related information is transmitted and shared bidirectionally through an MF and an SF (or MF-SAP and SF-SAP). The transfer of service messages and related information from the application layer to the facilities layer or from the facilities layer to the application layer is performed through an FA (or FA-SAP), and bidirectional service messages and related information between the facilities layer and the lower networking & transport layer are transmitted by an NF (or NF-SAP).

The network & transport layer servers to configure a network for vehicle communication between homogenous or heterogeneous networks through support of various transport protocols and network protocols. For example, the network & transport layer may provide Internet access, routing, and vehicle networking using Internet protocols such as TCP/UDP+IPv6 and form a vehicle network using a basic transport protocol (BTP) and GeoNetworking-based protocols. In this case, networking using geographic position information may also be supported. A vehicle network layer may be designed or configured depending on technology used for the access layer (access layer technology-independently) or regardless of the technology used for the access layer (access layer technology-independently or access layer technology agnostically).

Functionalities of the European ITS network & transport layer are as follows. Basically, functionalities of the ITS network & transport layer are similar to or identical to those of OSI layer 3 (network layer) and layer 4 (transport layer) and have the following characteristics.

The transport layer is a connection layer that delivers service messages and related information received from higher layers (the session layer, the presentation layer, and the application layer) and lower layers (the network layer, the data link layer, and the physical layer). The transport layer serves to manage data transmitted by an application of the ITS station so that the data accurately arrives at an application process of the ITS station as a destination. Transport protocols that may be considered in European ITS include, for example, TCP and UDP used as legacy Internet protocols, and there are transport protocols only for the ITS, such as the BTS.

The network layer serves to determine a logical address and a packet forwarding method/path, and add information such as the logical address of a destination and the forwarding path/method to a header of the network layer in a packet received from the transport layer. As an example of the packet method, unicast, broadcast, and multicast between ITS stations may be considered. Various networking protocols for the ITS may be considered, such as GeoNetworking, IPv6 networking with mobility support, and IPv6 over GeoNetworking. In addition to simple packet transmission, the GeoNetworking protocol may apply various forwarding paths or transmission ranges, such as forwarding using position information about stations including vehicles or forwarding using the number of forwarding hops.

Layer management related to the network & transport layer serves to manage and provide information related to the operation and security of the network & transport layer, and the related information is transmitted and shared bidirectionally through an MN (or MN-SAP) and an SN (or SN-SAP). Transmission of bidirectional service messages and related information between the facilities layer and the networking & transport layer is performed by an NF (or NF-SAP), and service messages and related information between the networking & transport layer and the access layer are exchanged by an IN (or IN-SAP).

A North American ITS network & transport layer supports IPv6 and TCP/UDP to support existing IP data like Europe, and a wave short message protocol (WSMP) is defined as a protocol only for the ITS.

A packet structure of a wave short message (WSM) generated according to the WSMP includes a WSMP header and WSM data carrying a message. The WSMP header includes Version, PSID, WSMP header extension fields, WSM WAVE element ID, and Length.

Version is defined by a WsmpVersion field indicating an actual WSMP version of 4 bits and a reserved field of 4 bits. PSID is a provider service identifier, which is allocated according to an application in a higher layer and helps a receiver to determine an appropriate higher layer. Extension fields is a field for extending the WSMP header, and includes information such as a channel number, a data rate, and transmit power used. WSMP WAVE element ID specifies the type of a WSM to be transmitted. Length specifies the length of transmitted WSM data in octets through a WSMLength field of 12 bits, and the remaining 4 bits are reserved. LLC Header allows IP data and WSMP data to be transmitted separately and is distinguished by Ethertype of a SNAP. The structures of the LLC header and the SNAP header are defined in IEEE802.2. When IP data is transmitted, Ethertype is set to 0x86DD in the LLC header. When WSMP is transmitted, Ethertype is set to 0x88DC in the LLC header. The receiver identifies Ethertype. If Ethertype is 0x86DD, the receiver transmits upward the packet to an IP data path, and if Ethertype is 0x88DC, the receiver transmits upward the packet to a WSMP path.

The access layer serves to transmit a message or data received from a higher layer on a physical channel. As access layer technologies, ITS-G5 vehicle communication technology based on IEEE 802.11p, satellite/broadband wireless mobile communication technology, 2G/3G/4G (long-term evolution (LTE), etc.)/5G wireless cellular communication technology, cellular-V2X vehicle-dedicated communication technologies such as LTE-V2X and NR-V2X (new radio), broadband terrestrial digital broadcasting technology such as DVB-T/T2/ATSC3.0, and GPS technology may be applied.

A data link layer is a layer that converts a physical line between adjacent nodes (or between vehicles) with noise into a communication channel without transmission error, for use in the higher network layer. The data link layer performs a function of transmitting/delivering/forwarding L3 protocols, a framing function of dividing data to be transmitted into packets (or frames) as transmission units and grouping the packets, a flow control function of compensating for a speed difference between a transmitter and a receiver, and a function of (because there is a high probability that an error and noise occurs randomly in view of the nature of a physical transmission medium) detecting a transmission error and correcting the error or detecting a transmission error based on a timer and an ACK signal by a transmitter in a method such as automatic repeat request (ACK) and retransmitting a packet that has not been correctly received. In addition, to avoid confusion between packets or ACK signals, the data link layer performs a function of assigning a sequence number to the packets and the ACK signals, and a function of controlling establishment, maintenance, and disconnection of a data link between network entities, and data transmission between network entities. The main functions of logical link control (LLC), radio resource control (RRC), packet data convergence protocol (PDCP), radio link control (RLC), medium access control (MAC), and multi-channel operation (MCO) included in the data link layer will be described below.

An LLC sub-layer enables the use of different lower MAC sub-layer protocols, and thus enables communication regardless of network topology. An RRC sub-layer performs functions such as broadcasting of cell system information required for all UEs within a cell, management of delivery of paging messages, management (setup/maintenance/release) of RRC connection between a UE and an E-UTRAN, mobility management (handover), transmission of UE context between eNodeBs during handover, UE measurement reporting and control therefor, UE capability management, temporary assignment of a cell ID to a UE, security management including key management, and RRC message encryption. A PDCP sub-layer may perform functions such as IP packet header compression in a compression method such as robust header compression (ROHC), cyphering of a control message and user data, data integrity, and data loss prevention during handover. RLC sub-layer delivers a packet received from the higher PDCP layer in an allowed size of the MAC layer through packet segmentation/concatenation, increases data transmission reliability by transmission error and retransmission management, checks the order of received data, reorders data, and checks redundancy. A MAC sub-layer performs functions such as control of the occurrence of collision/contention between nodes for use of shared media among multiple nodes, matching a packet delivered from the higher layer to a physical layer frame format, assignment and identification of the address of the transmitter/receiver, detection of a carrier, collision detection, and detection of obstacles on the physical medium. An MCO sub-layer enables efficient provision of various services on a plurality of frequency channels. The main function of MCO sub-layer is to effectively distribute traffic load of a specific frequency channel to other channels to minimize collision/contention of communication information between vehicles in each frequency channel.

The physical layer is the lowest layer in the ITS layer architecture. The physical layer defines an interface between a node and a transmission medium and performs modulation, coding, and mapping of a transport channel to a physical channel, for bit transmission between data link layer entities and informs the MAC sub-layer of whether a wireless medium is busy or idle by carrier sensing or clear channel assessment (CCA).

A Soft V2X system may be a system in which a Soft V2X server receives a VRU message or a personal safety message (PSM) from a vulnerable road user (VRU) or a V2X vehicle and transfers information on a neighbor VRU or vehicle based on the VRU message or the PSM message or may analyze a road condition, etc. on which neighbor VRUs or vehicles move and may transmit a message informing a neighbor VRU or vehicle of a collision warning, etc. based on the analyzed information (e.g., through a downlink signal) via V2X communication using a UU interface. Here, the VRU message may be a message transmitted to the Soft V2X server through the UU interface, and may include mobility information about the VRU, such as a position, a movement direction, a movement path, and a speed of the VRU. That is, the Soft V2X system may use a method of receiving mobility information of VRUs and/or vehicles related to V2X communication through the UU interface and controlling a driving route or a VRU movement flow of the VRU, etc. based on the mobility information received by the Soft V2X server, such as a network. The Soft V2X system may be configured in relation to V2N communication.

User equipment or pedestrian equipment (VRU device) that is difficult to perform direct communication (PC5, DSRC) related to V2X communication may provide or receive driving information and mobility information to nearby vehicles or VRUs through the Soft V2X system based on the UU interface. Through this, the user equipment or pedestrian equipment (VRU device) that is difficult to perform the direct communication (PC5, DSRC) may be protected from surrounding vehicles.

### Method of Managing V2X Information Based on Zone Using Transmission Control Protocol/Internet Protocol (TCP/IP)

Unlike the traditional broadcast communication method, such as short-range communication, where all surrounding UEs receive messages, in the case of V2N communication where V2X messages are transmitted using a cellular network, due to the characteristics of long-range communication, messages uploaded to a server through UL are classified according to a predetermined rule and then provided to each UE through DL. To this end, socket communication based on the TCP/IP in the cellular network is used. Accordingly, V2N communication systems using TCP/IP-based socket communication where the environment of V2X communication is analyzed will be described.

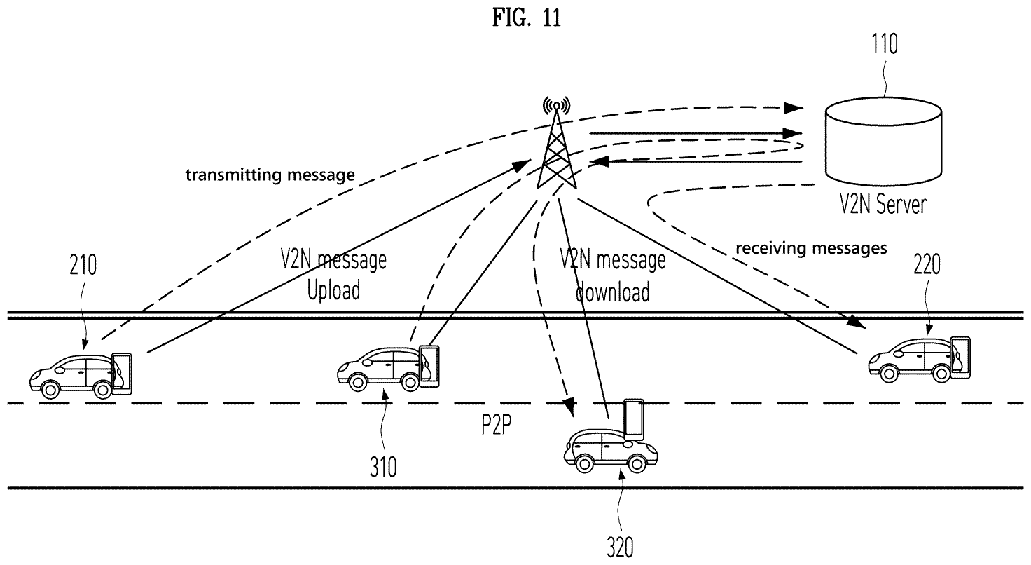

FIG. 11 is a diagram for explaining the configuration of a V2N communication system.

Traditional V2X communication using dedicated short-range communications (DSRC) may transmit signals over a distance of about 500 meters without the need for a server or management, and devices performing the communication may share information or communicate based on a common protocol. However, V2N communication allows all broadband devices to receive V2X-related information via the cellular network. Considering this, the V2N server may connect devices based on the types and/or statuses thereof and facilitate message exchanges between the devices or between the devices and the server.

Referring to FIG. 11, a V2N system may include vehicles (210, 310, 320, 330) equipped with UEs and a V2N server (110) that connects the vehicles (210, 310, 320, 330) through communication. The V2X UE (210) may not only have a capability to transmit messages to the V2N server (110) about the status thereof, but the V2X UE (210) may also receive messages from the V2N server (110) like a UE (220). The V2X UE (210) may communicate with a first vehicle (310) and a second vehicle (320) using short-range communication. However, actual data communication may be performed through message transmission and reception with the V2N server (110). Therefore, the V2N server (310) needs to transmit messages according to the location and situation of the UE.

In V2N communication, there are methods for connecting V2X communication between UEs, such as location-based connection methods and road information-based connection methods. The location-based connection method analyzes UEs located within a defined radius based on the location transmitted by a vehicle during the initial service connection. Based on the analysis results, TCP/IP sockets may be connected (messages are exchanged based on the connected TCP/IP sockets). However, the location-based connection method requires continuously detecting the positions of all vehicles and surrounding vehicles (or UEs) in the vicinity, and based on the detection results, calculating the relative distance between the vehicles (or UEs). Additionally, the location-based connection method may have the disadvantage of a communication list changing every time due to the movement of vehicles and the changes in the positions thereof

The road information-based connection method may include connecting TCP/IP sockets based on road IDs or zone information to manage devices. However, this method also faces operational constraints due to frequent changes in road location information and road IDs. For example, to effectively use the road information-based connection method, all UEs need to share common MAP information, and the MAP information needs to be updated in real-time according to the latest road information. Moreover, devices such as VRUs having no UEs on the road may face the issue of not being able to receive services based on the road information-based connection.

To address these issues, the global map may be divided into individual zones by simply partitioning the map into four directional tiles. This zone partitioning method allows for the division of zones in a simple and clear way unlike maps and also allows global zone IDs to be distinguished and identified with minimal data. V2N UEs may transmit messages to at least one of the UEs located in a specific zone ID based on the zone partitioning method. Furthermore, a V2N UE may receive messages transmitted by V2X UEs located around the zone where the V2N UE is located (or the zone ID corresponding to the location of the V2N UE) (through a V2N server). The V2N server has the advantage of not needing to track and manage the real-time locations of all UEs or exchange road-related information with all UEs. Instead, the V2N server only needs to update the list of UEs for each zone.

Hereinafter, methods by which a V2N server manages V2N messages or V2X messages based on zone IDs or zones will be described in detail.

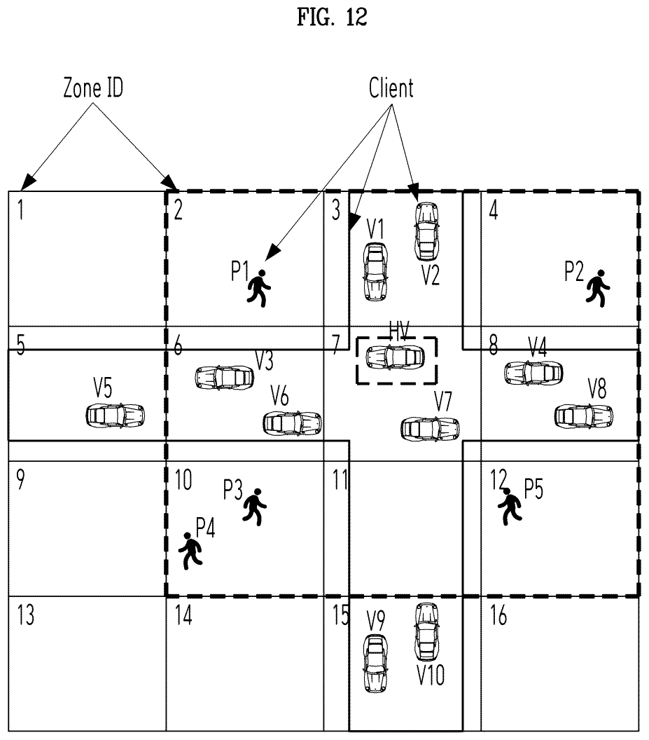

FIGS. 12 to 14 are diagrams for explaining methods for a V2N server to connect UEs based on zones.

Referring to FIG. 12, a host vehicle (HV) may perform an operation of transmitting and receiving messages from zones located in all directions around the HV. Here, the HV is located at zone ID=7, and as shown in Table 5, the V2N server may update a client list for each zone during the initial connection with the HV. Through the update of the client list for each zone, the HV may receive messages not only from devices corresponding to zone ID=7 but also receives (V2N) messages from devices located in surrounding zones in all directions. According to this method, the HV may receive safety messages from UEs located in all directions where risks may be detected (via the V2N server). For example, referring to FIG. 12, the HV may receive safety messages from UEs located in zones 2, 3, 4, 6, 7, 8, 10, 11, and 12 (both front and rear directions).

TABLE 5

| Zone | Client |
|---|---|
| 1 | None |
| 2 | P1 |
| 3 | V1, V2 |
| 4 | P2 |
| 5 | None |
| 6 | V3, V5, V6 |
| 7 | V7, HV1 |
| 8 | V4, V8 |
| 9 | None |
| 10 | P3, P4 |
| 11 | None |
| 12 | P5 |
| 13 | None |
| 14 | None |
| 15 | V9, V10 |
| 16 | None |

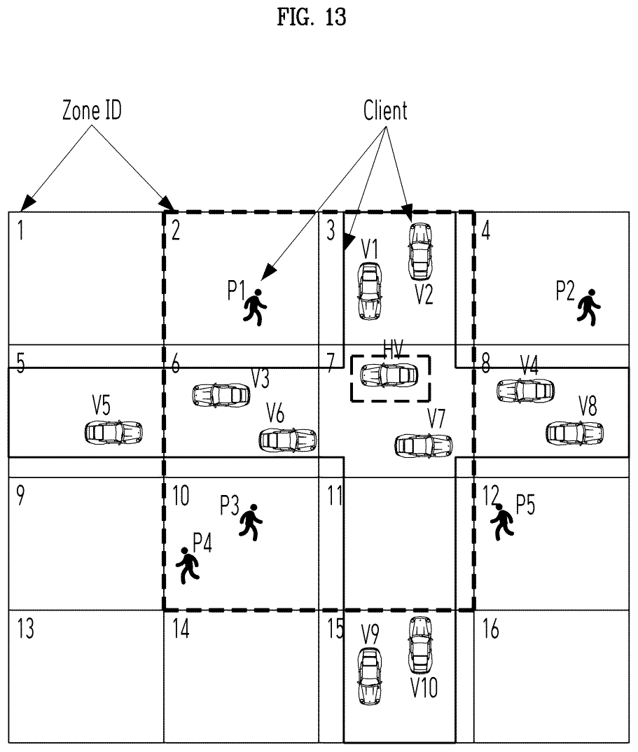

Alternatively, referring to FIG. 13, the HV may receive messages from devices (or UEs) located in zones in the direction of travel. Here, the HV is located at zone ID=7, and as shown in Table 6, the V2N server may update a client list for each zone during the initial connection with the HV. Through the update of the client list for each zone, the HV may receive messages not only from devices corresponding to zone ID=7 but also from devices located in zones in the front directions. The HV may receive safety messages only from UEs located in the direction of travel where risks may be detected (through the V2N server). For example, referring to FIG. 12, the HV may receive safety messages from devices (UEs and/or vehicles) located in zones 3, 6, 7, 10, and 11 (in the forward direction).

TABLE 6

| Zone | Client |
|---|---|
| 1 | None |
| 2 | P1 |
| 3 | V1, V2 |
| 4 | P2 |
| 5 | None |
| 6 | V3, V5, V6 |
| 7 | V7, HV1 |
| 8 | V4, V8 |
| 9 | None |
| 10 | P3, P4 |
| 11 | None |
| 12 | P5 |
| 13 | None |
| 14 | None |
| 15 | V9, V10 |
| 16 | None |

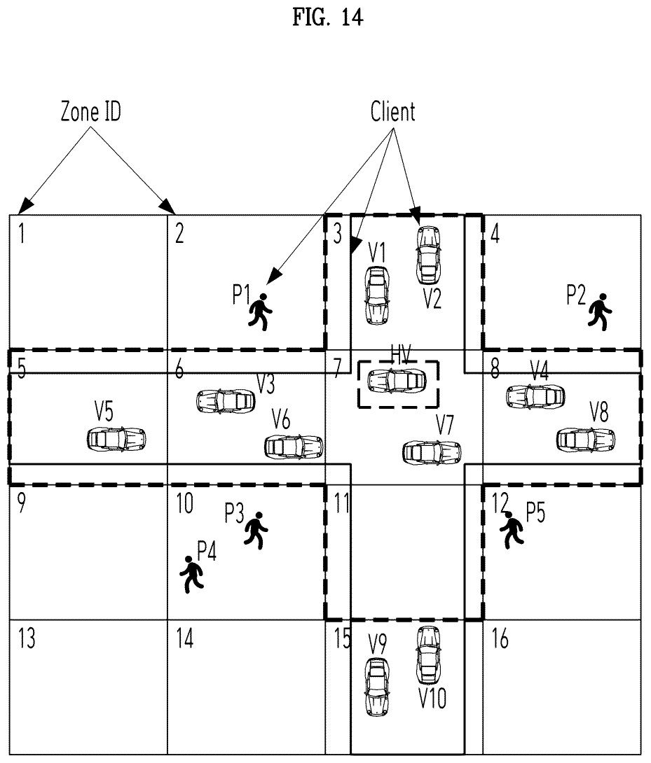

Alternatively, referring to FIG. 14, the HV may transmit and receive messages from risk zones where devices (or V2X UEs) are expected to be densely located. The HV is located at zone ID=7, and as shown in Table 7, the V2N server may update a client list for each zone during the initial connection with the HV. Subsequently, the HV may receive messages not only from zone ID=7 but also from devices located in zones with higher collision risks, such as roads or alleys around zone ID=7 or from zones with a high density of V2X UEs or devices. In this case, the HV may receive messages from devices located in zones with zone IDs of 3, 5, 6, 7, 8, and 11, while preventing messages from devices located in zones such as buildings or parks (i.e., zones with low collision risks) from being received.

TABLE 7

| Zone | Client |
|---|---|
| 1 | None |
| 2 | P1 |
| 3 | V1,V2 |
| 4 | P2 |
| 5 | None |
| 6 | V3, V5, V6 |
| 7 | V7, HV1 |
| 8 | V4, V8 |
| 9 | None |
| 10 | P3, P4 |
| 11 | None |
| 12 | P5 |
| 13 | None |
| 14 | None |
| 15 | V9, V10 |
| 16 | None |

Hereinafter, the configuration of a V2N server that performs the method of connecting devices based on zone IDs will be described in detail.

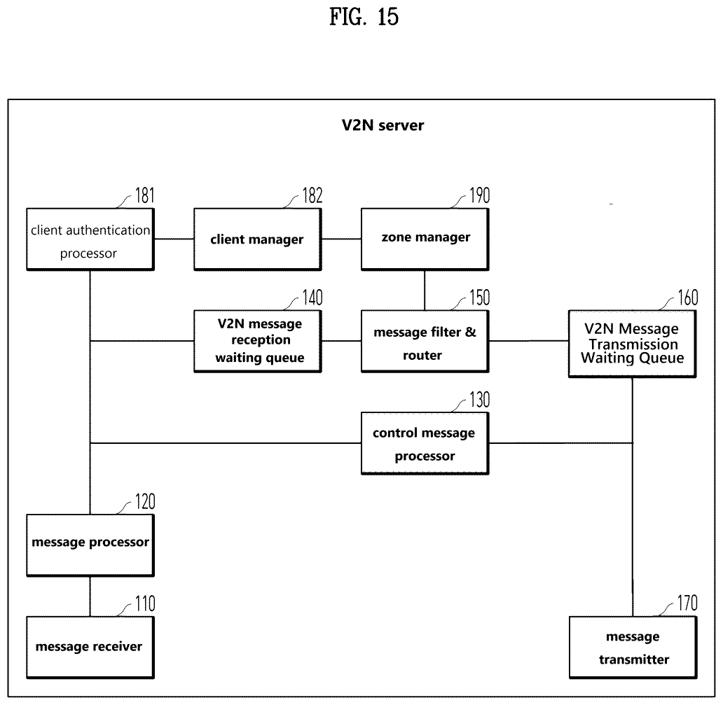

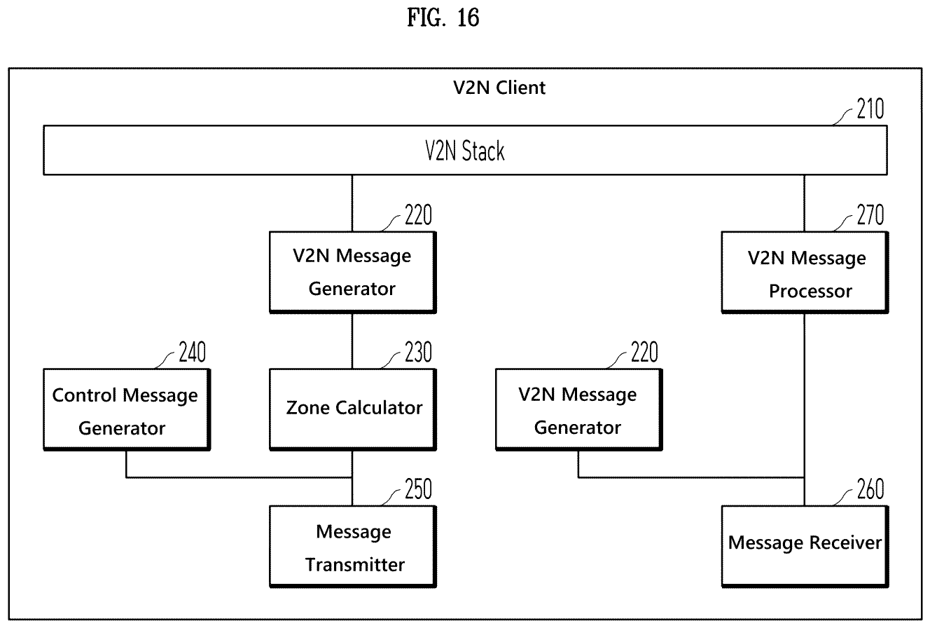

FIGS. 15 and 16 are block diagrams schematically illustrating the configurations of a V2N server and V2N client transmitting and receiving messages based on a zone ID.

For convenience of explanation, a UE or device receiving V2N services will be defined as a V2N client.

Referring to FIG. 15, a V2N server may include a message receiver (110), a message processor (120), a control message processor (130), a V2N message reception waiting queue (140), a message filter & router block (150), a V2N message transmission waiting queue (160), a message transmitter (170), a client authentication processor (180), a client manager (190), and a zone manager (200).

The message receiver (110) is a module that receives client messages (or messages from devices) via a TCP/IP. The message processor (120) is a module that processes the received messages. The message processor (120) may handle the received messages based on the type of message. For V2N messages, the message processor (120) may transmit a received V2N message to the V2N message reception waiting queue to forward the message to nearby other clients (V2N devices, V2N UEs, or devices). For control messages, the message processor (120) may transmit a control message to the control message processor (130) to process the control message immediately. The control message processor (130) is a module that handles control messages between the server and client (V2N device, V2N UE, or device). The control message may include messages for client registration, authentication, and so on.

The V2N message reception waiting queue (140) is a space where the received V2N message is temporarily stored. The received V2N message may be processed according to scheduling of the V2N server. The message filter & router block (150) is a module that selects and maps the client to which the received V2N message will be delivered. The message filter & router block (150) selects and maps the client to which the message will be delivered based on the following conditions: i) the client has the same zone ID or an adjacent zone ID as the zone ID of the received message, and ii) the client (V2N device or device) is not excluded according to filtering by client types. Additionally, the message may be routed to a client configured to receive all V2N messages or to other servers.

The V2N message transmission waiting queue (160) is a space where the V2N message whose recipient is determined/selected by the message filter & router (150) is temporarily stored. The message transmitter (170) is a module that transmits messages to clients via the TCP/IP. The client authentication processor (180) is a module responsible for authenticating clients. Only authenticated clients may use V2N services. The client manager (190) is a module that manages registered clients. The zone manager (200) is a module that manages a list or table of clients located in each zone. When a V2N message is delivered from a client, the zone manager (200) may update the client list for each zone.

Referring to FIG. 16, a V2N client may include a V2X stack (210), a V2N message generator (220), a location zone calculator (230), a control message generator (240), a message transmitter (250), and a message receiver (260).

The V2X stack (210) is a module responsible for handling V2X-related services. The V2N message generator (220) is a module that generates V2N messages. The V2N message generator (220) may generate the V2N messages based on location information, sensor data, vehicle information, and so on. The location zone calculator (230) is a module that calculates a zone based on location information on a vehicle (i.e., determining a zone ID corresponding to the location of the vehicle). The control message generator (240) is a module that generates control messages. Here, the control messages may be used for registering or authenticating a V2N client with a V2N server. The message transmitter (250) is a module that transmits messages to the V2N server via a TCP/IP. The message receiver (260) is a module that receives messages from the TCP/IP. A V2N message processor (270) is a module that processes V2N messages received from the server. The received V2N messages may be forwarded to the V2X stack (210). The control message processor (280) is a module that processes control messages received from the server.

The proposed V2N server may manage and update V2N client and/or zone lists. The operation of converting location information into a zone ID may be performed either by the V2N server or the V2N client. On the other hand, the management of the zone lists may be centrally managed by the V2N server or distributedly managed by the V2N clients.

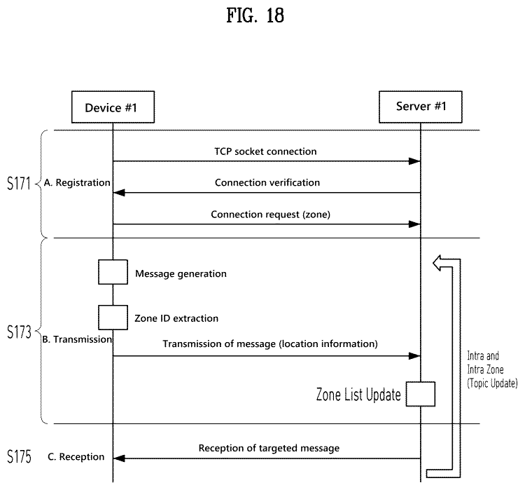

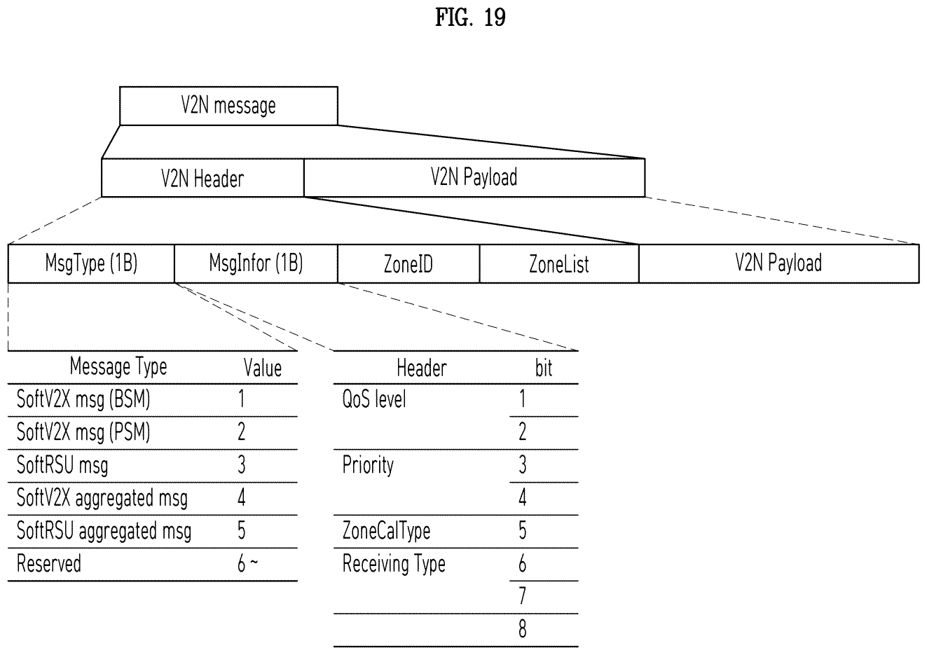

Hereinafter, methods by which a V2N server converts a zone ID and manages a zone list will be described with reference to FIG. 18. In addition, methods by which a V2N client performs an operation of extracting/converting a zone ID and a V2N server manages a zone list will be described with reference to FIG. 19.

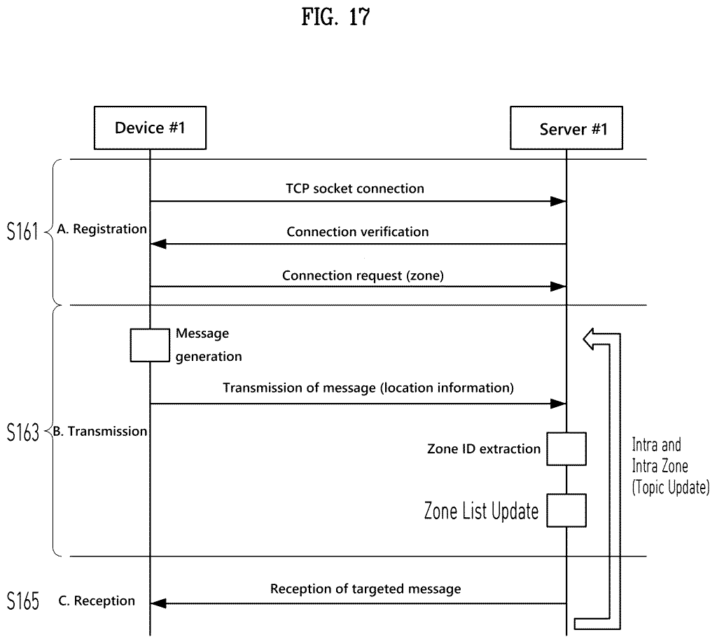

FIGS. 17 and 18 are diagrams for explaining methods of converting location information into a zone ID and managing a zone list.

Referring to FIG. 17, a V2N server may extract a zone ID from location information on a V2N client and manage a zone list, such as updating the zone list (centralized processing). When the V2N client initially connects or registers with V2N services, the V2N client may exchange connection information with the V2N server by registering with the server. Through this initial connection or registration, the V2N client may establish a TCP/IP (socket) connection with the V2N server (S161). Subsequently, the V2N client may generate a V2X message and transmit a V2N message containing the V2X message (or generate a V2X message as a packet and transmit the V2X message based on the configuration of a V2N message). The V2N message may consist of a V2N header and a payload containing the V2X message. The V2N header may include location information related to the V2N client. The V2N server may extract the zone or zone ID based on the location information included in the V2N header of the V2N message received from the V2N client. Based on the extracted zone ID, the V2N server may register the V2N client in the zone (client) list (S163). The V2N client may receive V2N-related services from the V2N server based on the zone list automatically updated by the V2N server, without performing any operations related to Zone Subscribe in Message Queuing Telemetry Transport (MQTT) (S165).

Referring to FIG. 18, a V2N server may perform management operations related to updates of a zone list, and operations related to extraction of a zone ID may be distributed to a V2N client. At the beginning of services, the V2N client and server exchange connection information through a registration process and may be connected via a TCP/IP (S171). Subsequently, the V2N client may generate a V2X message, extract the zone ID based on location information on the V2N client, and transmit a V2N message containing information on the zone ID and the V2X message to the V2N server (S173). The V2N client may receive V2N messages targeted at nearby devices or surrounding UEs based on the zone list (S175). The zone ID may be transmitted to the V2N server during the initial connection or registration process for receiving V2N services, or when the V2N client moves to a new zone and the zone ID changes.

Hereinafter, the structure of a V2N message transmitted to a V2N server will be described in detail.

FIG. 19 is a diagram for explaining the structure of a V2N message.

Referring to FIG. 19, the V2N message may include a V2N payload that contains a generated V2X message such as a BSM or PSM. In other words, the V2X message may be directly transmitted through the V2N payload of the V2N message. For efficient transmission of the V2N message or V2X message, a V2N header may provide the message type and message information of the V2X message (or V2N message) through the following fields: messageType and MessageInfo.

MsgInfo may provide or configure information about a zone ID calculation method through ZoneCalType and ReceivingType. For example, when ZoneCalType is ‘0’, it indicates that the operation of calculating/extracting a location-based zone ID is performed by the V2N server. When ZoneCalType is ‘l’, it indicates that the V2N client directly calculates/extracts the zone ID based on location information. ReceivingType is a field used to inform the server about the zone or zone ID to be received. The V2N client may inform the V2N server about the zone ID the V2N client desires to receive through ReceivingType. When ReceivingType is ‘O’, it indicates that the V2N client receives messages from devices located in zones in all directions (based on the zone ID thereof). When ReceivingType is ‘l’, it indicates that the V2N client receives messages from devices located in zones in the direction of travel (based on the zone ID thereof). When ReceivingType is ‘2’, it indicates that the V2N client receives messages from devices located in zones with high collision risks among the surrounding zones (based on the zone ID thereof). When ReceivingType is ‘4’ (or ‘3’), it indicates that the V2N client receives messages only from devices located in the same zone as the zone ID of the V2N client or from zones specifically designated by the V2N client. ZoneID and ZoneList may be optional fields. ZoneID may indicate the zone location of the client, while ZoneList may provide information about zones from which the client desires to receive messages.

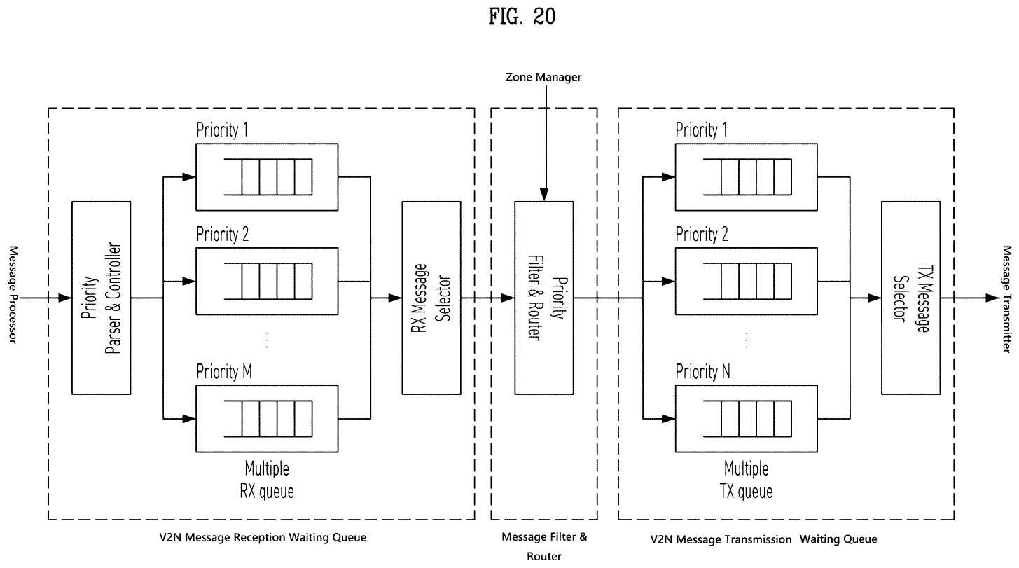

FIG. 20 is a diagram for explaining the configuration of a V2N server including V2N message reception queues and transmission queues.

Referring to FIG. 20, a V2N server may perform message transmission and reception operations based on multiple queues. The V2N messages received from UEs or devices need to have various priorities based on the types, locations, or statuses of the UEs or devices. However, in the prior art, the V2N server simply transmits the received V2N messages without distinguishing the V2N messages based on the priorities. In other words, in the prior art, received V2N messages are not forwarded with consideration of priorities. Considering this, the UE may transmit a V2N message with an additional priority field. The V2N server may classify the received V2N messages based on the priorities, configure multiple reception queues for the classified V2N messages, and allow different processing speeds for the received V2N messages.

The UE (or transmitter) may configure the priority field as ‘emergency mode (emergency priority)’, ‘safety mode (safety priority)’, ‘normal mode (normal priority)’, or ‘low mode (low priority)’ depending on the status of the message. The UE may configure the priority of a V2N message containing event information, such as a decentralized environmental notification message (DENM), to the emergency mode and transmit the V2N message. The V2N server may assign the V2N message with the emergency mode priority to a reception queue with the first priority (priority 1). Messages included in the reception queue with the first priority (priority 1) may be forwarded to a transmission queue with the first priority (priority 1) as the highest priority (i.e., before messages in other priority reception queues).

Alternatively, the UE may configure the priority of a periodically transmitted message such as a CAM to the safety mode and transmit the message. The V2N server may assign the V2N message with the safety mode priority to a reception queue with the second priority (priority 2). Within the maximum waiting time, the V2N message with the safety mode priority may be forwarded to a transmission queue in coordination with the reception queue with the first priority (priority 1). The received V2N messages may be distributed/classified into multiple transmission queues based on the reception type.

Alternatively, the V2N server may forward the received V2N message with the normal mode priority to the transmission queue when the reception queues for the emergency mode and safety mode are empty. For the received V2N message with the low mode priority, the V2N server may determine whether to forward the V2N message to the transmission queue by considering whether congestion in the V2N server and network is expected in the future, based on the operational status of the V2N server and the network.

The V2N server may adjust the reception area of a V2N message based on the status of the server by using the multiple transmission queues. The V2N server may configure the priorities of the multiple transmission queues based on information about the reception area configured by the UE. The V2N server may transmit messages in the transmission queues by considering the transmission status of received V2N messages. The received V2N message in the reception queue with the first priority (priority 1) may be forwarded to the transmission queue with the first priority (priority 1), regardless of the location of the area corresponding to the received V2N message. The UE may be configured with one of the following reception methods related to the configurations of the reception area: all-direction reception, reception prioritizing the direction of travel, and/or reception prioritizing risk areas. The UE may select one of these methods and provide information on the reception area or message reception type to the V2N server.

FIGS. 21 to 23 are diagrams for explaining methods for a V2N server to forward received V2N messages to a UE based on the reception area configuration of the UE.

The priorities of zones for an HV located in zone 13 and based on the all-direction reception method may be configured as shown in FIG. 21. Specifically, based on the reception method, the V2N server may configure/assign the priorities of the zones such that the priority values increase in a square shape centered with respect to the zone where the HV is located (zone 13) (that is, the priorities decreases). Based on the assigned priorities, the server may assign/configure the zones or zone IDs corresponding to each of multiple transmission queues (alternatively, for the all-direction reception method of the HV, when the HV is located in zone ID=13, the priority is assigned such that the priority number increases in a square shape centered with respect to the zone, and a messages may be input into the transmission waiting queue according to the assigned priority number). The V2N server may prioritize dropping transmission of a V2N message received from a zone with a lower priority (i.e., a zone with a higher priority value) based on the status of the V2N server and channel. For example, the V2N server may input a V2N message from a device in a zone with a lower priority into a transmission queue with a lower priority among the transmission queues. Based on the status of the channel and/or V2N server, the V2N server may prioritize dropping transmission of the V2N message input into the lower-priority transmission queue.

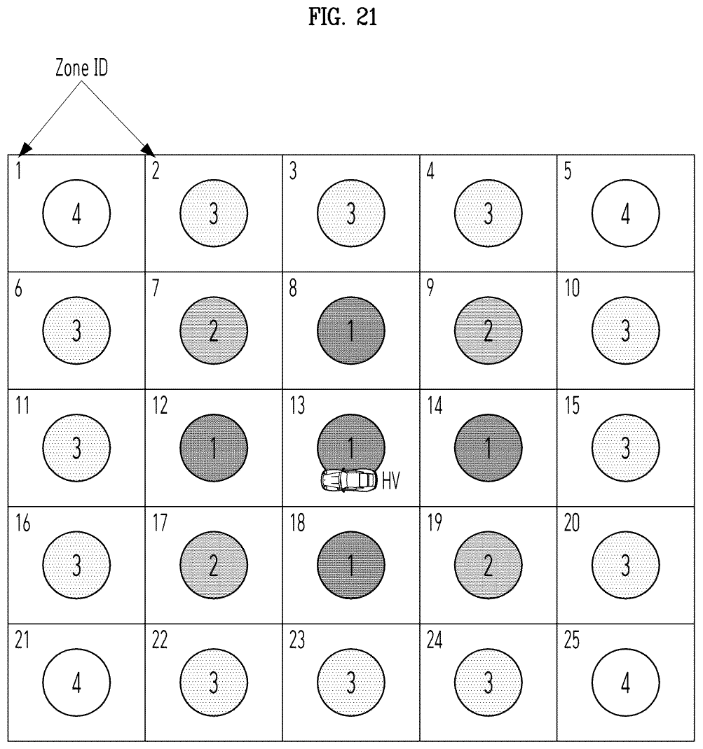

Alternatively, the priorities of zones for an HV located in zone 13 and based on the reception method prioritizing the direction of travel may be configured as shown in FIG. 22 (a) and FIG. 22 (b). Specifically, the priorities of the zones may be configured such that a zone located in the travelling direction of the HV with respect to zone 13 has a higher priority. For example, as shown in FIG. 22 (a), zones 7, 8, 12, 13, 17, and 18 may be assigned priority 1. In this case, the V2N server may input V2N messages received from devices located in zones 7, 8, 12, 13, 17, and 18 into the transmission queue with priority 1. The V2N server may then prioritize transmission of the received V2N messages in the transmission queue with priority 1 and forward the V2N messages to the HV before messages input into other transmission queues. Alternatively, referring to FIG. 22 (b), priority 1 may be assigned to zones 1, 7, 8, 12, and 13. In this case, the V2N server may input V2N messages received from devices located in zones 1, 7, 8, 12, and 13 into the transmission queue with priority 1. The V2N server may then prioritize transmission of the received V2N messages in the transmission queue with priority 1 and forward the V2N messages to the HV before messages input into other transmission queues (i.e., transmission queues with relatively lower priorities).

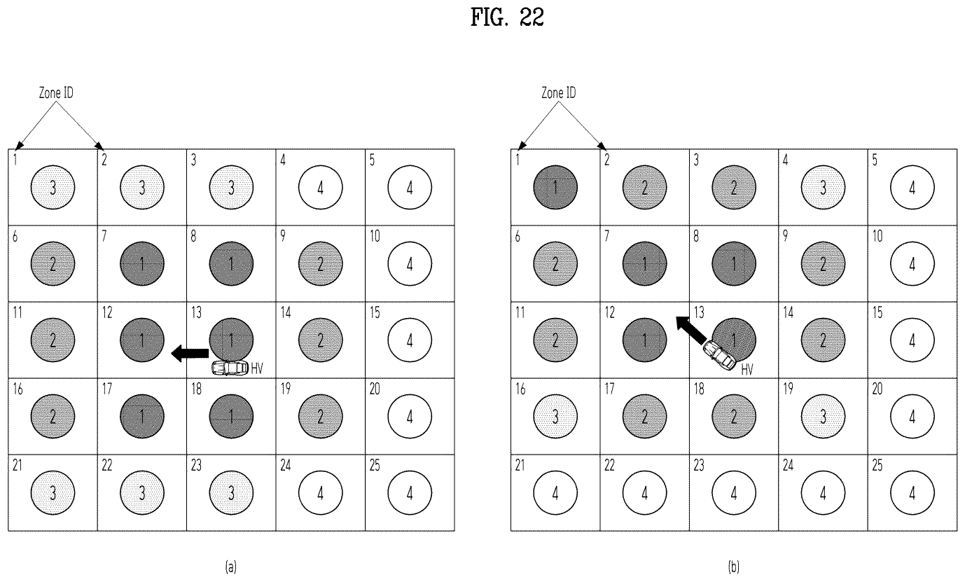

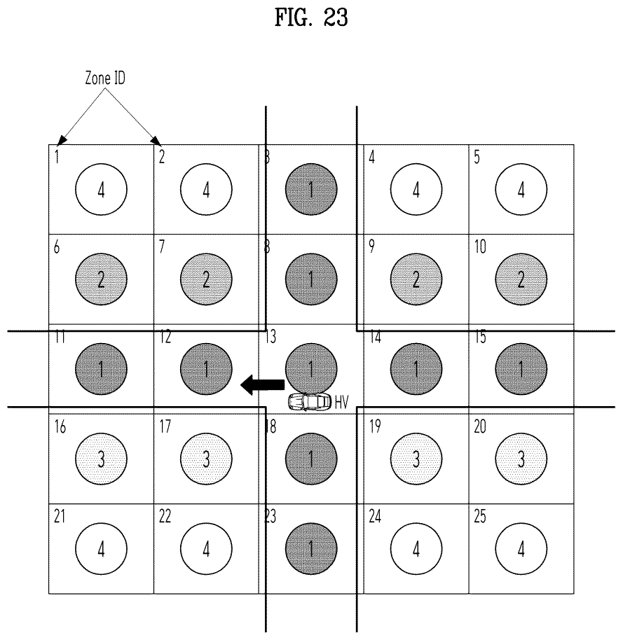

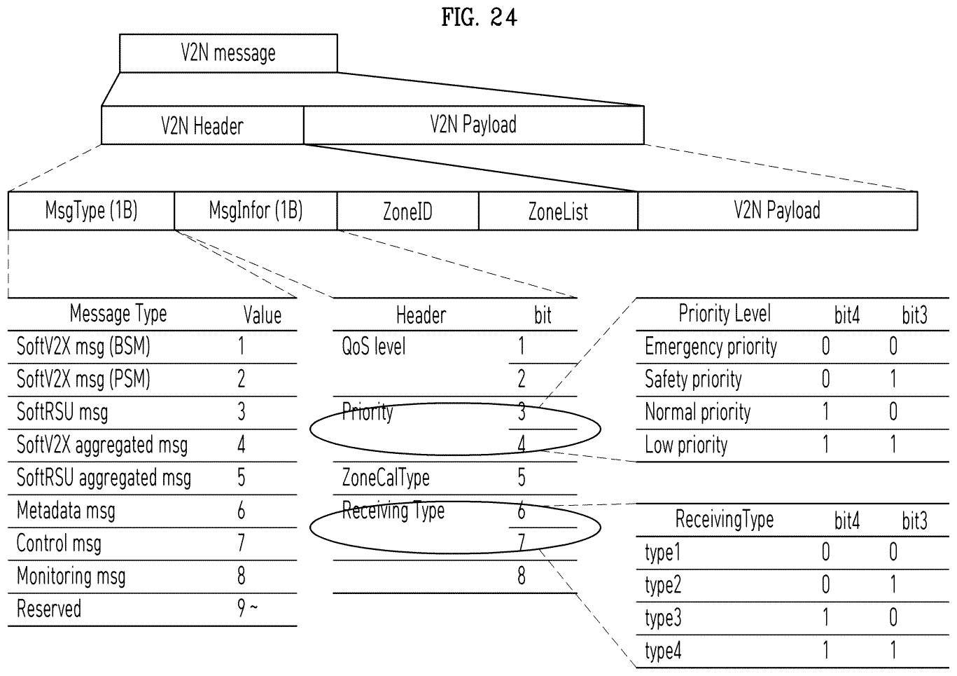

Alternatively, the priorities of zones of an HV located in zone 13 and based on the reception method prioritizing risk areas may be configured as shown in FIG. 23. Specifically, the V2N server may continuously assess the risk level of each zone by considering the location changes of devices and accident situations in each zone. Based on the evaluation, the server may assign a higher priority to a zone that are evaluated as risky. For example, as shown in FIG. 24, priority 1 may be assigned to zones 3, 8, 11, 12, 13, 14, 15, 18, and 23. In this case, the V2N server may input V2N messages received from devices located in zones 3, 8, 11, 12, 13, 14, 15, 18, and 23 into the transmission queue with priority 1. The V2N server may then prioritize transmission of the received V2N messages in the transmission queue with priority 1 and forward the V2N messages to the HV before the messages input into other transmission queues.

Hereinafter, the structure of a V2N message will be described based on the above-mentioned content.

FIG. 24 is a diagram for explaining the structure of a V2N message including information on a priority and a reception type.

Referring to FIG. 24, a V2N message may consist of a V2N header and a V2N payload containing a generated V2X message such as a BSM and PSM. The V2N header may include the following fields: messageType and MsgInfo (message type and message information). MsgInfo may contain information about Priority and ReceivingType, which may be used for the efficient operation of transmission and reception buffers based on the priority.

The third and fourth bits of MsgInfo may be set to different values based on the following modes: emergency transmission mode, safety transmission mode, normal transmission mode, and low transmission mode. For example, 00 indicates the emergency transmission mode, 01 indicates the safety transmission mode, 10 indicates the normal transmission mode, and 11 indicates the low transmission mode. ReceivingType may be configured as follows: ‘00’ indicates the all-direction reception method (type 1), ‘01’ indicates the reception method prioritizing the direction of travel (type 2), ‘10’ indicates the reception method prioritizing risk areas (type 3), and ‘1 1’ indicates a reception method prioritizing zones directly specified by the UE (type 4). ZoneID and ZoneList may be optional fields. Zone ID indicates the location of a zone corresponding to location information on the UE, while ZoneList may specify zones from which the UE desires to receive messages.

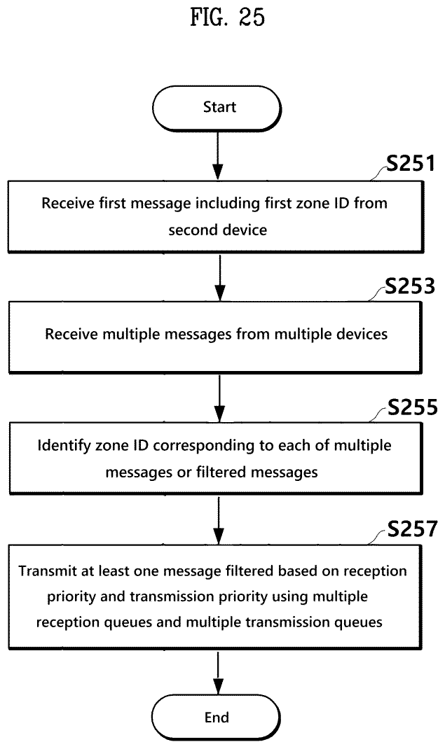

FIG. 25 is a diagram for explaining a method by which a first device transmits a V2N message to a second device.

The first device may include multiple reception queues configured with reception priorities and multiple transmission queues configured with transmission priorities, as described above. The first device may filter at least one message to transmit to the second device from multiple messages transmitted by multiple devices related to the second device, based on the reception priorities and transmission priorities. Here, the first device may be a V2N server providing V2N services, and the second device may be a UE or V2N client that is registered for and receive the V2N services.

Referring to FIG. 25, the first device may receive a first message containing a first zone ID from the second device (S251). As explained with reference to FIG. 24, the first message may include information about the first zone ID corresponding to the location of the second device and a message reception type. As explained with reference to FIGS. 22 to 25, the message reception type may be any one of the following: a reception type prioritizing all directions, a reception type prioritizing the direction of travel, a reception type prioritizing risk areas, and a reception type prioritizing designated zones. Alternatively, the first message includes a V2N header configured with a field including information about the first zone ID and the message reception type. The first device may obtain the information about the first zone ID and the message reception type from the V2N header without decoding the payload (V2N payload) of the first message.

The first device may preconfigure the transmission priority for each of multiple zones based on the first zone ID and the message reception type. For example, when the message reception type included in the first message is the reception type prioritizing all directions, the first device may configure/determine the transmission priority for each of multiple zone IDs (or multiple zones) related to the second device, based on the distance between each of the multiple zone IDs related to the second device and an area corresponding to the first zone ID, as shown in FIG. 21. For instance, the first device may configure a relatively higher transmission priority (i.e., a transmission priority with a relatively lower value) for the zone ID of a zone close to the area corresponding to the first zone ID.

Alternatively, when the message reception type included in the first message is the reception type prioritizing the direction of travel, the first device may configure/determine the transmission priority for each of the multiple zone IDs (or multiple zones) related to the second device, based on the distance between each of the multiple zone IDs related to the second device and the area corresponding to the first zone ID and based on the direction of travel of the second device (obtained based on mobility information included in the first message), as shown in FIG. 22. For example, the first device may configure a relatively higher transmission priority (i.e., a transmission priority with a relatively lower value) for the zone ID of an area that is close to the area corresponding to the first zone ID and located in the movement direction of the second device, among the multiple zone IDs

Alternatively, when the message reception type included in the first message is the reception type prioritizing risk areas, the first device may evaluate the risk level for each of the multiple zone IDs based on past data, such as accident occurrence situations in the area corresponding to the first zone ID and changes in the locations of other devices, as shown in FIG. 23. The first device may then configure the transmission priority for each of the multiple zone IDs based on the evaluated risk level. For example, when the second device is related to a vehicle driving on a road, the first device may configure higher transmission priorities for the zone IDs of zones where the road exists, among the multiple zone IDs. Alternatively, the first device may configure lower transmission priorities (i.e., transmission priorities with higher values) for the zone IDs of zones such as parks or buildings, compared to other zones.

Alternatively, when the message reception type included in the first message is the reception type prioritizing designated zones, the first message may include the target zone IDs of zones where the second device desires to receive, among the multiple zone IDs. In this case, the first device may configure higher transmission priorities (i.e., transmission priorities with lower values) for the target zone IDs, compared to other zone IDs, as shown in FIG. 24.

Next, the first device may receive multiple messages from multiple devices (S253). The first device may determine the reception priority for each of the multiple messages based on the message type of each message. For example, as explained with reference to FIG. 24, the multiple messages may include information related to the reception priority in the MsgInfo field. Specifically, the information related to the reception priority may include information one of the following: an emergency transmission mode (e.g., DENM), a safety transmission mode (e.g., BSM, PSM, etc.), a normal transmission mode (e.g., collective perception message (CPM)), and a low transmission mode (e.g., message for assistance data). In this case, the first device may determine a message for the emergency transmission mode among the multiple message as a first priority, determine a message for the safety transmission mode as a second priority, determine a message for the normal transmission mode as a third priority, and determine a message for the low transmission mode as a fourth priority. The priorities decrease in the order of the first priority, second priority, third priority, and fourth priority. For example, the first priority may be relatively prioritized over the other priorities. Additionally, each of the reception queues corresponds to one of the first priority, second priority, third priority, and fourth priority. Alternatively, each of the multiple messages includes a V2N header containing information related to the reception priority for the message type, and the first device may determine the reception priority for each of the multiple messages based on the V2N header. In this case, the first device may determine the reception priority for each of the multiple messages based on the V2N header, without decoding the payload (V2N payload) of each message.

Here, as described above, the multiple messages may be V2N messages, and the message may include one of the following messages in the payload: a CAM, a DENM, a BSM, and a CPM.

For example, based on the reception priority determined for each of the multiple messages, the first device may input each message into a reception queue that has a priority corresponding to the reception priority for each message among the multiple reception queues. For example, among the multiple messages, if the reception priority of a first received message is the first priority and the reception priority of a second received message is the second priority, the first device may input the first received message into a reception queue with the first priority and the second received message into a reception queue with the second priority.

The first device may select at least one reception queue to be transmitted to multiple transmission queues from multiple reception queues based on the first priority. The first device may transmit/input messages input into the selected at least one reception queue (hereinafter, referred to as filtered messages) to the multiple transmission queues. For example, the first device may select at least one reception queue to be input to the multiple transmission queues from the multiple reception queues, by considering at least one of the current communication load of the V2N server, the device density around the second device, or the movement speed of the second device. For example, if the movement speed of the second device is more than or equal to a specific threshold, the first device selects a reception queue with the highest first priority from the multiple reception queues. The first device may transmit/input filtered messages, which are messages input into the reception queue with the first priority, to the multiple transmission queues.

Next, the first device may identify a zone ID corresponding to each of the multiple messages or filtered messages (S255). For example, if each of the multiple messages contains a zone ID, the first device may identify the zone ID corresponding to each message based on information on the zone ID included in each of the multiple messages. Alternatively, if each of the multiple messages contains location information, the first device may extract/identify the zone ID of a zone that the location information in each message belongs to from pre-divided multiple zones. The first device may determine the transmission priority of each message based on the zone ID identified/extracted for each message. As mentioned above, the first device may preconfigure the transmission priority for each of the multiple zone IDs based on the first zone ID and the message reception type. The first device may determine the transmission priority corresponding to the identified/extracted zone ID based on the transmission priorities preconfigured for the multiple zone IEs.

For example, the first device may determine the transmission priority based on the zone ID identified for each of the filtered messages included in the selected reception queue. The first device may input each filtered message into one of the multiple transmission queues based on the determined transmission priority. In other words, the first device may determine the transmission priority configured for the zone ID identified for each of the filtered messages, based on the transmission priorities preconfigured for the multiple zone IDs. For example, if the transmission priority for a first filtered message is determined as a first transmission priority, and if the transmission priority for a second filtered message is determined as a second transmission priority, the first device may transmit/input the first filtered message into a transmission queue with the first transmission priority among the multiple transmission queues and transmit/input the second filtered message into a transmission queue with the second transmission priority among the multiple transmission queues.

Next, the first device may transmit at least one message filtered based on the reception priority and transmission priority to the second device, using the multiple reception queues and multiple transmission queues (S257). For example, as mentioned above, the first device may input multiple messages into the reception queues based on the reception priority. Then, the first device may filter messages to be first processed from the multiple messages based on the reception priority and input the filtered messages into the multiple transmission queues. The first device may select at least one transmission queue from the multiple transmission queues based on the transmission priority and then transmit at least one message input into the selected at least one transmission queue to the first device.

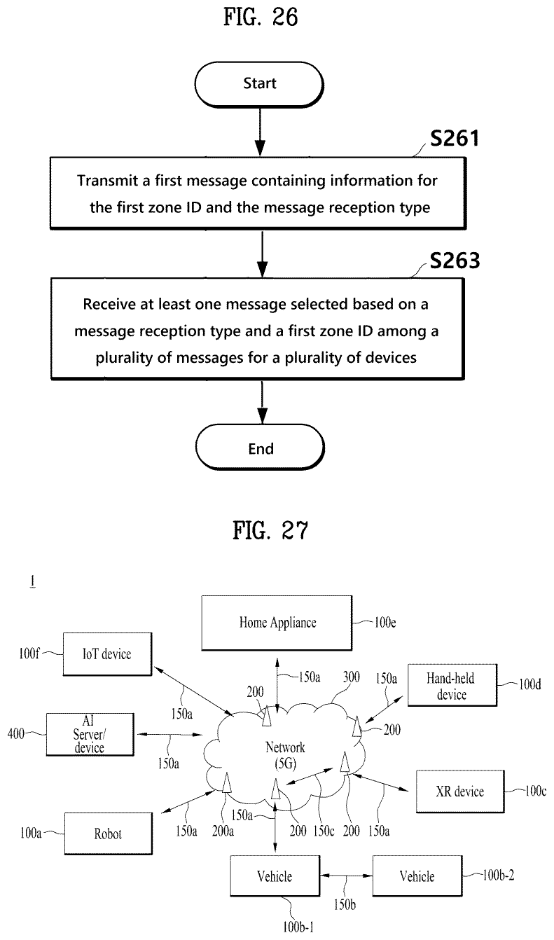

FIG. 26 is a diagram for explaining a method by which a second device receives a message from a first device.

Referring to FIG. 26, the second device may transmit a first message including information about a first zone ID and a message reception type to the first device (S261).

As mentioned above, the message reception type may indicate one of the following: a reception type prioritizing all directions, a reception type prioritizing the direction of travel, reception type prioritizing risk areas, and a reception type prioritizing designated zones. The message reception type and the first zone ID may be used by the second to prioritize and receive V2N messages from devices located in zones of interest to the second device.

Next, the second device may receive at least one message filtered from multiple messages for multiple devices based on the message reception type and the first zone ID from the first device (S263).

As mentioned above, the first device may prioritize and filter at least one message for devices located in the zones of interest to the second device from the multiple messages, based on the operation of reception queues according to the reception priority for the message type of each of the multiple messages and the operation of transmission queues according to the transmission priority for the zone ID of each of the multiple messages. The first device may then transmit the filtered at least one message to the second device. That is, as explained with reference to FIG. 25, the second device may prioritize and receive the at least one message filtered by the first device from the multiple messages for the multiple devices based on the reception priority and transmission priority.

Accordingly, the first device may select at least one reception queue from multiple reception queues based on the reception priority and transmit messages input into the selected at least one reception queue to multiple transmission queues. By doing so, the first device may filter messages that need to be processed first based on the message type from the multiple messages. Additionally, based on the transmission priority, the first device may prioritize and transmit at least one message input into the at least one transmission queue selected from the multiple transmission queues to the second device, thereby filtering messages that need to be transmitted first based on the zone ID. Even when broadband communication is performed based on a cellular network, the first device may easily and quickly filter out the messages that need to be transmitted to the second device from the multiple messages through such filtering, based on the operation of the multiple reception queues and transmission queues according to the priority configured for the message type and zone ID of a message. The first device may prioritize and transmit only the filtered messages to the second device.

Communication System Example to which the Present Disclosure is Applied

Although not limited thereto, various descriptions, functions, procedures, proposals, methods, and/or operational flow charts of the present disclosure disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

FIG. 27 illustrates a communication system applied to the present disclosure.

Referring to FIG. 27, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g., relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Examples of Wireless Devices to which the Present Disclosure is Applied

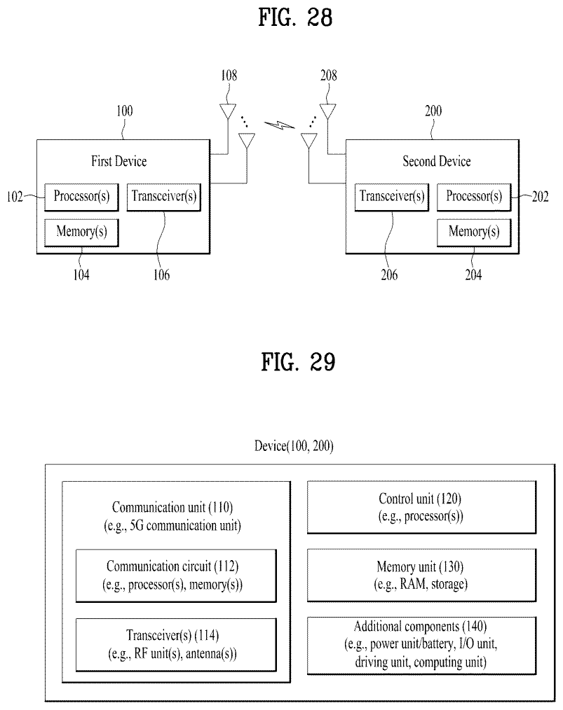

FIG. 28 illustrates a wireless device applicable to the present disclosure.

Referring to FIG. 28, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 27.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

Specifically, the first wireless device or first device 100 may include the processor(s) 102 connected to the transceiver(s) 106 and the memory(s) 104. The memory(s) 104 may include at least one program capable of performing operations related to the embodiments described in FIGS. 11 to 25.

The processor(s) 102 may control the transceiver(s) 106 to receive a first message including a first zone ID from a second device, receive a plurality of messages from a plurality of devices, identify a zone ID corresponding to each of the plurality of messages, and transmit at least one message to the second device. The plurality of messages may be input into reception queues based on a reception priority determined based on a message type. Filtered messages included in at least one reception queue, which is selected based on the reception priority from the reception queues into which the plurality of messages are input, may be input into transmission queues based on a transmission priority corresponding to the identified zone ID. The at least one message may be a message included in at least one transmission queue selected based on the transmission priority from the transmission queues into which the filtered messages are input.

Alternatively, the processor(s) 102 and memory(s) 104 may be a processing device configured to control a first device having reception queues and transmission queues. The processing device may include at least one processor and at least one memory operatively connected to the at least one processor, and when executed, causes the at least one processor to perform operations. The operations may include: receiving a first message including a first zone ID from a second device; receiving a plurality of messages from a plurality of devices; identifying a zone ID corresponding to each of the plurality of messages; and transmitting at least one message to the second device. The plurality of messages may be input into the reception queues based on a reception priority determined based on a message type. Filtered messages included in at least one reception queue, which is selected based on the reception priority from the reception queues into which the plurality of messages are input, may be input into the transmission queues based on a transmission priority corresponding to the identified zone ID. The at least one message may be a message included in at least one transmission queue selected based on the transmission priority from the transmission queues into which the filtered messages are input.

Alternatively, there is provided a non-transitory computer-readable storage medium having recorded thereon instructions that, when executed, cause a first device to: receive a first message including a first zone ID from a second device; receive a plurality of messages from a plurality of devices; identify a zone ID corresponding to each of the plurality of messages; and transmit at least one message to the second device. The plurality of messages may be input into reception queues based on a reception priority determined based on a message type. Filtered messages included in at least one reception queue, which is selected based on the reception priority from the reception queues into which the plurality of messages are input, may be input into transmission queues based on a transmission priority corresponding to the identified zone ID. The at least one message may be a message included in at least one transmission queue selected based on the transmission priority from the transmission queues into which the filtered messages are input.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

The second wireless device 200 or second device may be a UE or a V2N client receiving V2N services. The processor(s) 202 may control the transceiver(s) 206 to transmit a first message including information on a first zone ID and a message reception type to a first device; and receive at least one message among a plurality of messages for a plurality of devices from the first device. The plurality of messages may be input into reception queues based on a reception priority determined based on a message type. Filtered messages included in at least one reception queue, which is selected based on the reception priority from the reception queues into which the plurality of messages are input, may be input into transmission queues based on a transmission priority corresponding to the identified zone ID. The at least one message may be a message included in at least one transmission queue selected based on the transmission priority from the transmission queues into which the filtered messages are input.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of Wireless Devices to which the Present Disclosure is Applied

FIG. 29 illustrates another example of a wireless device applied to the present disclosure. The wireless device may be implemented in various forms according to a use-case/service (refer to FIG. 27)

Referring to FIG. 29, wireless devices 100 and 200 may correspond to the wireless devices 100 and 200 of FIG. 28 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 28. For example, the transceiver(s) 114 may include the one or more transceivers 106 and 206 and/or the one or more antennas 108 and 208 of FIG. 28. The control unit 120 is electrically connected to the communication unit 110, the memory 130, and the additional components 140 and controls overall operation of the wireless devices. For example, the control unit 120 may control an electric/mechanical operation the wireless device based of on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 27), the vehicles (100b-1 and 100b-2 of FIG. 27), the XR device (100c of FIG. 27), the hand-held device (100d of FIG. 27), the home appliance (100e of FIG. 27), the IoT device (100f of FIG. 27), a digital broadcast terminal, a hologram device, a public safety device, an MTC device, a medicine device, a fintech device (or a finance device), a security device, a climate/environment device, the AI server/device (400 of FIG. 27), the BSs (200 of FIG. 27), a network node, etc. The wireless device may be used in a mobile or fixed place according to a use-example/service.

In FIG. 29, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Examples of Vehicles or Autonomous Vehicles to which the Present Disclosure is Applied

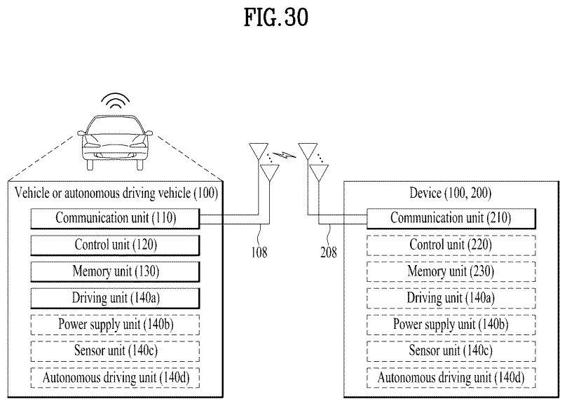

FIG. 30 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 30, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 27, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). Also, the driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the acquired data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly acquired data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Here, wireless communication technologies implemented in the wireless devices (XXX, YYY) of the present specification may include LTE, NR, and 6G, as well as Narrowband Internet of Things for low power communication. At this time, for example, the NB-IOT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present specification may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present specification is at least one of ZigBee, Bluetooth, and Low Power Wide Area Network (LPWAN) considering low power communication, and is not limited to the above-described names. As an example, ZigBee technology may generate personal area networks (PANs) related to small/low-power digital communication based on various standards such as IEEE 802.15.4, and may be called various names.

The embodiments described above are those in which components and features of the present disclosure are combined in a predetermined form. Each component or feature should be considered optional unless explicitly stated otherwise. Each component or feature may be implemented in a form that is not combined with other components or features. In addition, it is also possible to constitute an embodiment of the present disclosure by combining some components and/or features. The order of operations described in the embodiments of the present disclosure may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present disclosure have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure. For example, those skilled in the art may use the components described in the foregoing embodiments in combination. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The above-described embodiments of the present disclosure are applicable to various mobile communication systems.

1. A method by a first device comprising,
receiving a first message comprising a first zone identifier (ID) from a second device;
receiving a plurality of messages from a plurality of devices;
identifying a zone ID corresponding to each of the plurality of messages; and
transmitting at least one message to the second device,
wherein the plurality of messages are input into reception queues based on a reception priority determined based on a message type,
wherein filtered messages included in at least one reception queue selected from the reception queues based on the reception priority are input, are input into transmission queues based on a transmission priority corresponding to the identified zone ID, and
wherein the at least one message is a message included in at least one transmission queue selected based on the transmission priority from the transmission queues into which the filtered messages are input.

2. The method of claim 1, wherein each of the plurality of messages is input into a reception queue with the determined reception priority among the reception queues, and
wherein each of the filtered messages is input into a transmission queue with the transmission priority corresponding to the identified zone ID among the transmission queues.

3. The method of claim 1, wherein the at least one reception queue is a reception queue with a relatively higher reception priority among the reception queues, and
wherein the at least one transmission queue is a transmission queue with a relatively higher transmission priority among the transmission queues.

4. The method of claim 1, wherein the first message comprises a vehicle-to-network (V2N) header including information on the first zone ID and a message reception type, and
wherein the transmission priority is preconfigured for each of a plurality of zone IDs based on the message reception type and the first zone ID included in the V2N header.

5. The method of claim 4, wherein the message reception type indicates one of a reception type prioritizing all directions, a reception type prioritizing a direction of travel, a reception type prioritizing risk areas, or reception type prioritizing designated zones.

6. The method of claim 4, wherein based on that the message reception type is the reception type prioritizing all directions, the transmission priority is preconfigured for each of the plurality of zone IDs based on a distance to an area corresponding to the first zone ID.

7. The method of claim 4, wherein based on that the message reception type is the reception type prioritizing the direction of travel, the transmission priority is preconfigured for each of the plurality of zone IDs based on a distance to an area corresponding to the first zone ID and the direction of travel of the second device.

8. The method of claim 4, wherein based on that the message reception type is the reception type prioritizing the risk areas, the transmission priority is preconfigured for each of the plurality of zone IDs based on accident occurrences in an area corresponding to the first zone ID and changes in locations of other devices.

9. The method of claim 1, wherein the first device is a vehicle-to-network (V2N) server, and
wherein each of the first message and the plurality of messages is a V2N message transmitted to the V2N server.

10. The method of claim 1, wherein each of the plurality of messages comprises a vehicle-to-network (V2N) header including information related to the reception priority for the message type, and
wherein the first device determines the reception priority for each of the plurality of messages based on the V2N header.

11. (canceled)

12. A first device comprising:
a radio frequency (RF) transceiver; and
a processor connected to the RF transceiver,
wherein the processor is configured to:
control the RF transceiver to receive a first message comprising a first zone identifier (ID) from a second device;
receive a plurality of messages from a plurality of devices;
identify a zone ID corresponding to each of the plurality of messages; and
transmit at least one message to the second device,
wherein the plurality of messages are input into the reception queues based on a reception priority determined based on a message type,
wherein filtered messages included in at least one reception queue, selected from the reception queues based on the reception priority are input into transmission queues based on a transmission priority corresponding to the identified zone ID, and
wherein the at least one message is a message included in at least one transmission queue selected based on the transmission priority from the transmission queues into which the filtered messages are input.

13. (canceled)

14. A method by a second device comprising:
transmitting a first message comprising information on a first zone identifier (ID) and a message reception type to the first device; and
receiving at least one message among a plurality of messages for a plurality of devices from the first device,
wherein the plurality of messages are input into reception queues based on a reception priority determined based on a message type,
wherein filtered messages included in at least one reception queue selected from the reception queues based on the reception priority are input into transmission queues based on a transmission priority corresponding to the identified zone ID, and
wherein the at least one message is a message included in at least one transmission queue selected based on the transmission priority from the transmission queues into which the filtered messages are input.

15.-17. (canceled)
